(19) United States
(12) Patent Application Publication
(10) Pub. No.: US 2026/0087475 A1
(43) Pub. Date: Mar. 26, 2026

(54) SYSTEMS AND METHODS TO CONTROL VISION CAMERAS

(71) Applicant: Zebra Technologies Corporation, Lincolnshire, IL (US)

(72) Inventors: Edward Barkan, Miller Place, NY (US); Darran Michael Handshaw, Sound Beach, NY (US)

(21) Appl. No.: 18/894,127

(22) Filed: Sep. 24, 2024

(51) Int. Cl. G06Q 20/20; H04N 23/61; H04N 23/67; H04N 23/73

(52) U.S. Cl. CPC G06Q 20/208; H04N 23/61; H04N 23/675; H04N 23/73

(57) ABSTRACT

Systems and methods for controlling vision cameras are provided herein. An example method may include determining that an object is within a first focus range associated with an imaging sensor. The example method may further include adjusting a focus of the imaging sensor to the first focus range. The example method may further include capturing first imaging data that is representative of the object in the first focus range. The example method may further include determining that the object is within a second focus range associated with the imaging sensor. The example method may further include adjusting the focus of the imaging sensor to the second focus range. The example method may further include capturing second imaging data that is representative of the object in the second focus range.

### BACKGROUND

Computer vision systems enable machines to interpret and process visual information from the surrounding environment using cameras. Variable focus cameras can maintain a sharp image focus on a subject, the image focus can be influenced by the lens, focal length, and aperture size of the camera. Fixed focus cameras have lenses set to focus on a specific distance from the camera which can ensure that everything within a certain range is in focus without additional adjustments.

### SUMMARY

Apparatuses and methods for controlling vision cameras are provided herein. In an example embodiment, a product scanner may comprise a housing, an indicia scanner, and/or an imaging system. In a variation of this example embodiment, the indicia scanner may comprise an optical light source, an optical sensor, and a lens. In a variation of this example embodiment, the indicia scanner may be configured to capture indicia data from a product indicia disposed within an indicia scan region. In a variation of this example embodiment, the indicia scan region may be defined by an optical field-of-view of the optical sensor. In a variation of this example embodiment, the imaging system may comprise an imaging sensor comprising an imaging field-of-view. In a variation of this example embodiment, the imaging field-of-view may comprise a first focus range and/or a second focus range. In a variation of this example embodiment, the imaging system may be configured to determine that an object is within the first focus range. In a variation of this example embodiment, the imaging system may be configured to adjust a focus of the imaging sensor to the first focus range. In a variation of this example embodiment, the imaging system may be configured to capture first imaging data that is representative of the object in the first focus range of the imaging field-of-view. In a variation of this example embodiment, the imaging system may be configured to determine that the object is within the second focus range. In a variation of this example embodiment, the imaging system may be configured to adjust the focus of the imaging sensor to the second focus range. In a variation of this example embodiment, the imaging system may be configured to capture second imaging data that is representative of the object in the second focus range of the imaging field-of-view.

In a variation of this example embodiment, the imaging field-of-view may comprise a central axis extending perpendicularly from the imaging sensor. In a variation of this example embodiment, the first focus range comprises a first lower boundary (or limit) and a first upper boundary (or limit). In a variation of this example embodiment, the first lower boundary is disposed along the central axis at a first lower distance from the imaging sensor. In a variation of this example embodiment, the first upper boundary is disposed along the central axis at a first upper distance from the imaging sensor.

In a variation of this example embodiment, the second focus range comprises a second lower boundary and a second upper boundary. In a variation of this example embodiment, the second lower boundary is disposed along the central axis at a second lower distance from the imaging sensor. In a variation of this example embodiment, the second upper boundary is disposed along the central axis at a second upper distance from the imaging sensor.

In a variation of this example embodiment, the product scanner may comprise a detection sensor. In a variation of this example embodiment, the detection sensor may comprise at least one of a 3D sensor, a range finder, and/or an infrared sensor. In a variation of this example embodiment, the detection sensor may be configured to detect the object at a position within the imaging field-of-view. In a variation of this example embodiment, the detection sensor may be configured to generate a detection signal that is representative of at least one of (i) the position within the imaging field-of-view and/or (ii) a distance between the position and the imaging sensor. In a variation of this example embodiment, the detection sensor may be configured to cause transmission of the detection signal to the imaging system.

In a variation of this example embodiment, the imaging system may comprise a second imaging sensor. In a variation of this example embodiment, the second imaging sensor may comprise a second imaging field-of-view. In a variation of this example embodiment, the second imaging field-of-view may comprise a third focus range and/or a fourth focus range. In a variation of this example embodiment, the imaging system may be configured to determine that the object is within the third focus range. In a variation of this example embodiment, the imaging system may be configured to adjust a focus of the second imaging sensor to the third focus range. In a variation of this example embodiment, the imaging system may be configured to capture third imaging data that is representative of the object in the third focus range of the second imaging field-of-view. In a variation of this example embodiment, the imaging system may be configured to determine that the object is within the fourth focus range. In a variation of this example embodiment, the imaging system may be configured to adjust the focus of the imaging sensor to the second focus range. In a variation of this example embodiment, the imaging system may be configured to capture fourth imaging data that is representative of the object in the fourth focus range of the second imaging field-of-view.

In a variation of this example embodiment, the second imaging field-of-view comprises a second central axis extending perpendicularly from the second imaging sensor. In a variation of this example embodiment, the third focus range comprises a third lower boundary and a third upper boundary. In a variation of this example embodiment, the third lower boundary is disposed along the second central axis at a third lower distance from the imaging sensor. In a variation of this example embodiment, the third upper boundary is disposed along the second central axis at a third upper distance from the second imaging sensor.

In a variation of this example embodiment, the fourth focus range comprises a fourth lower boundary and a fourth upper boundary. In a variation of this example embodiment, the fourth lower boundary is disposed along the second central axis at a fourth lower distance from the second imaging sensor. In a variation of this example embodiment, the fourth upper boundary is disposed along the second central axis at a fourth upper distance from the second imaging sensor.

In a variation of this example embodiment, the imaging field-of-view of the imaging sensor comprises an overlap region that overlaps, at least in part, with the second imaging field-of-view of the second imaging sensor. In a variation of this example embodiment, the imaging system may be configured to detect the object at a position within the overlap region based on a parallax between the imaging sensor and the second imaging sensor.

In a variation of this example embodiment, the position within the overlap region may be further within (i) the second focus range of the imaging sensor and/or (ii) the third focus range of the second imaging sensor. In a variation of this example embodiment, the imaging system may be configured to adjust the focus of the imaging sensor to the second focus range. In a variation of this example embodiment, the imaging system may be configured to adjust the focus of the second imaging sensor to the third focus range. In a variation of this example embodiment, the imaging system may be configured to determine that the object was scanned by the indicia scanner. In a variation of this example embodiment, the imaging system may be configured to search for another object within at least one of (i) the first focus range of the imaging sensor and/or (ii) the fourth focus range of the second imaging sensor.

In a variation of this example embodiment, the position within the overlap region may be further within (i) the first focus range of the imaging sensor and/or (ii) the fourth focus range of the second imaging sensor. In a variation of this example embodiment, the imaging system may be configured to adjust the focus of the imaging sensor to the first focus range. In a variation of this example embodiment, the imaging system may be configured to adjust the focus of the second imaging sensor to the fourth focus range. In a variation of this example embodiment, the imaging system may be configured to determine that the object by-passed the indicia scanner. In a variation of this example embodiment, the imaging system may be configured to detect that the object is in a bagging area. In a variation of this example embodiment, the imaging system may be configured to generate an alert signal that indicates at least one of an instance of scan avoidance or that the object by-passed the indicia scanner.

In a variation of this example embodiment, the imaging sensor may comprise a first imaging sensor comprising a first fixed focus within the first focus range. In a variation of this example embodiment, the imaging sensor may comprise a second imaging sensor comprising a second fixed focus within the second focus range. In a variation of this example embodiment, the imaging system may be configured to adjust the focus of the imaging sensor by switching between the first imaging sensor and the second imaging sensor.

In a variation of this example embodiment, the imaging system may be configured to perform one or more of increasing or decreasing a brightness, increasing or decreasing an exposure length, increasing or decreasing a gain, increasing or decreasing a zoom, increasing or decreasing a field-of-view angle, increasing or decreasing a readout limit, or switching between imaging light sources.

In a variation of this example embodiment, the imaging system may be configured to execute a machine vision application. In a variation of this example embodiment the machine vision application may be configured to perform one or more operations described herein. In a variation of this example embodiment, the machine vision application may be configured to detect one or more of the object or other item in a basket or a cart based, at least in part, on the first imaging data. In a variation of this example embodiment, the object or the other item may be located at a bottom of the basket or under the cart. In a variation of this example embodiment, the machine vision application may be configured to identify the object based on at least one of the first imaging data or the second imaging data. In a variation of this example embodiment, the machine vision application may be configured to decode the product indicia from at least one of the first imaging data or the second imaging data. In a variation of this example embodiment, the machine vision application may be configured to determine that the indicia data does not represent the object associated with the first imaging data or the second imaging data. In a variation of this example embodiment, the machine vision application may be configured to generate an alert signal that indicates an instance of ticket switching. In a variation of this example embodiment, the imaging system may be configured to adjust the focus of one or more of the imaging sensor or a second imaging sensor to focus on the object or a user in response to one or more of an instance of scan avoidance or an instance of ticket switching.

In another example embodiment, an imaging system may comprise an imaging sensor. In a variation of this example embodiment, the imaging sensor may comprise an imaging field-of-view. In a variation of this example embodiment, the imaging field-of-view may comprise a first focus range and/or a second focus range. In a variation of this example embodiment, the imaging system may be configured to determine that an object is within the first focus range. In a variation of this example embodiment, the imaging system may be configured to adjust a focus of the imaging sensor to the first focus range. In a variation of this example embodiment, the imaging system may be configured to capture first imaging data that is representative of the object in the first focus range of the imaging field-of-view. In a variation of this example embodiment, the imaging system may be configured to determine that the object is within the second focus range. In a variation of this example embodiment, the imaging system may be configured to adjust the focus of the imaging sensor to the second focus range. In a variation of this example embodiment, the imaging system may be configured to capture second imaging data that is representative of the object in the second focus range of the imaging field-of-view.

In a variation of this example embodiment, the imaging system may comprise a detection sensor. In a variation of this example embodiment, the detection sensor may comprise at least one of a 3D sensor, a range finder, and/or an infrared sensor. In a variation of this example embodiment, the detection sensor may be configured to detect the object at a position within the imaging field-of-view. In a variation of this example embodiment, the detection sensor may be configured to generate a detection signal that is representative of at least one of (i) the position within the imaging field-of-view and/or (ii) a distance between the position and the imaging sensor. In a variation of this example embodiment, the detection sensor may be configured to cause transmission of the detection signal to the imaging system.

In a variation of this example embodiment, the imaging system may comprise a second imaging sensor. In a variation of this example embodiment, the second imaging sensor may comprise a second imaging field-of-view. In a variation of this example embodiment, the second imaging field-of-view may comprise a third focus range and/or a fourth focus range. In a variation of this example embodiment, the imaging system may be configured to determine that the object is within the third focus range. In a variation of this example embodiment, the imaging system may be configured to adjust a focus of the second imaging sensor to the third focus range. In a variation of this example embodiment, the imaging system may be configured to capture third imaging data that is representative of the object in the third focus range of the second imaging field-of-view. In a variation of this example embodiment, the imaging system may be configured to determine that the object is within the fourth focus range. In a variation of this example embodiment, the imaging system may be configured to adjust the focus of the imaging sensor to the second focus range. In a variation of this example embodiment, the imaging system may be configured to capture fourth imaging data that is representative of the object in the fourth focus range of the second imaging field-of-view.

In a variation of this example embodiment, the imaging field-of-view of the imaging sensor comprises an overlap region that overlaps, at least in part, with the second imaging field-of-view of the second imaging sensor. In a variation of this example embodiment, the imaging system may be configured to detect the object at a position within the overlap region based on a parallax between the imaging sensor and the second imaging sensor.

In a variation of this example embodiment, the position within the overlap region may be further within (i) the second focus range of the imaging sensor and/or (ii) the third focus range of the second imaging sensor. In a variation of this example embodiment, the imaging system may be configured to adjust the focus of the imaging sensor to the second focus range. In a variation of this example embodiment, the imaging system may be configured to adjust the focus of the second imaging sensor to the third focus range. In a variation of this example embodiment, the imaging system may be configured to determine that the object was scanned by an indicia scanner. In a variation of this example embodiment, the imaging system may be configured to search for another object within at least one of (i) the first focus range of the imaging sensor and/or (ii) the fourth focus range of the second imaging sensor.

In a variation of this example embodiment, the position within the overlap region may be further within (i) the first focus range of the imaging sensor and/or (ii) the fourth focus range of the second imaging sensor. In a variation of this example embodiment, the imaging system may be configured to adjust the focus of the imaging sensor to the first focus range. In a variation of this example embodiment, the imaging system may be configured to adjust the focus of the second imaging sensor to the fourth focus range. In a variation of this example embodiment, the imaging system may be configured to determine that the object by-passed the indicia scanner. In a variation of this example embodiment, the imaging system may be configured to detect that the object is in a bagging area. In a variation of this example embodiment, the imaging system may be configured to generate an alert signal that indicates at least one of an instance of scan avoidance or that the object by-passed the indicia scanner.

In a variation of this example embodiment, the imaging sensor may comprise a first imaging sensor comprising a first fixed focus within the first focus range. In a variation of this example embodiment, the imaging sensor may comprise a second imaging sensor comprising a second fixed focus within the second focus range. In a variation of this example embodiment, the imaging system may be configured to adjust the focus of the imaging sensor by switching between the first imaging sensor and the second imaging sensor.

In a variation of this example embodiment, the imaging system may be configured to execute a machine vision application. In a variation of this example embodiment the machine vision application may be configured to perform one or more operations described herein. In a variation of this example embodiment, the machine vision application may be configured to detect one or more of the object or other item in a basket or a cart based, at least in part, on the first imaging data. In a variation of this example embodiment, the object or the other item may be located at a bottom of the basket or under the cart. In a variation of this example embodiment, the machine vision application may be configured to identify the object based on at least one of the first imaging data or the second imaging data. In a variation of this example embodiment, the machine vision application may be configured to decode the product indicia from at least one of the first imaging data or the second imaging data. In a variation of this example embodiment, the machine vision application may be configured to determine that the indicia data does not represent the object associated with the first imaging data or the second imaging data. In a variation of this example embodiment, the machine vision application may be configured to generate an alert signal that indicates an instance of ticket switching. In a variation of this example embodiment, the imaging system may be configured to adjust the focus of one or more of the imaging sensor or a second imaging sensor to focus on the object or a user in response to one or more of an instance of scan avoidance or an instance of ticket switching.

In another example embodiment, a computer-implemented method may comprise determining that an object is within a first focus range associated with an imaging sensor. In a variation of this example embodiment, the computer-implemented method may comprise adjusting a focus of the imaging sensor to the first focus range. In a variation of this example embodiment, the computer-implemented method may comprise capturing first imaging data that is representative of the object in the first focus range. In a variation of this example embodiment, the computer-implemented method may comprise determining that the object is within a second focus range associated with the imaging sensor. In a variation of this example embodiment, the computer-implemented method may comprise adjusting the focus of the imaging sensor to the second focus range. In a variation of this example embodiment, the computer-implemented method may comprise capturing second imaging data that is representative of the object in the second focus range.

In a variation of this example embodiment, the computer-implemented method may comprise capturing indicia data from a product indicia disposed within an indicia scan region. In a variation of this example embodiment, the indicia scan region may be defined by an optical field-of-view of the optical sensor.

In a variation of this example embodiment, the imaging field-of-view may comprise a central axis extending perpendicularly from the imaging sensor. In a variation of this example embodiment, the first focus range comprises a first lower boundary and a first upper boundary. In a variation of this example embodiment, the first lower boundary is disposed along the central axis at a first lower distance from the imaging sensor. In a variation of this example embodiment, the first upper boundary is disposed along the central axis at a first upper distance from the imaging sensor.

In a variation of this example embodiment, the second focus range comprises a second lower boundary and a second upper boundary. In a variation of this example embodiment, the second lower boundary is disposed along the central axis at a second lower distance from the imaging sensor. In a variation of this example embodiment, the second upper boundary is disposed along the central axis at a second upper distance from the imaging sensor.

In a variation of this example embodiment, the computer-implemented method may comprise detecting the object at a position within the imaging field-of-view. In a variation of this example embodiment, the computer-implemented method may comprise generating a detection signal that is representative of at least one of (i) the position within the imaging field-of-view or (ii) a distance between the position and the imaging sensor. In a variation of this example embodiment, the computer-implemented method may comprise causing transmission of the detection signal to the imaging system.

In a variation of this example embodiment, the computer-implemented method may comprise determining that the object is within the third focus range. In a variation of this example embodiment, the computer-implemented method may comprise adjusting a focus of the second imaging sensor to the third focus range. In a variation of this example embodiment, the computer-implemented method may comprise capturing third imaging data that is representative of the object in the third focus range of the second imaging field-of-view. In a variation of this example embodiment, the computer-implemented method may comprise determining that the object is within the fourth focus range. In a variation of this example embodiment, the computer-implemented method may comprise adjusting the focus of the imaging sensor to the second focus range. In a variation of this example embodiment, the computer-implemented method may comprise capturing fourth imaging data that is representative of the object in the fourth focus range of the second imaging field-of-view.

In a variation of this example embodiment, the second imaging field-of-view comprises a second central axis extending perpendicularly from the second imaging sensor. In a variation of this example embodiment, the third focus range comprises a third lower boundary and a third upper boundary. In a variation of this example embodiment, the third lower boundary is disposed along the second central axis at a third lower distance from the imaging sensor. In a variation of this example embodiment, the third upper boundary is disposed along the second central axis at a third upper distance from the second imaging sensor.

In a variation of this example embodiment, the fourth focus range comprises a fourth lower boundary and a fourth upper boundary. In a variation of this example embodiment, the fourth lower boundary is disposed along the second central axis at a fourth lower distance from the second imaging sensor. In a variation of this example embodiment, the fourth upper boundary is disposed along the second central axis at a fourth upper distance from the second imaging sensor.

In a variation of this example embodiment, the imaging field-of-view of the imaging sensor comprises an overlap region that overlaps, at least in part, with the second imaging field-of-view of the second imaging sensor. In a variation of this example embodiment, the computer-implemented method may comprise detecting the object at a position within the overlap region based on a parallax between the imaging sensor and the second imaging sensor.

In a variation of this example embodiment, the position within the overlap region may be further within (i) the second focus range of the imaging sensor and/or (ii) the third focus range of the second imaging sensor. In a variation of this example embodiment, the computer-implemented method may comprise adjusting the focus of the imaging sensor to the second focus range. In a variation of this example embodiment, the computer-implemented method may comprise adjusting the focus of the second imaging sensor to the third focus range. In a variation of this example embodiment, the computer-implemented method may comprise determining that the object was scanned by the indicia scanner. In a variation of this example embodiment, the computer-implemented method may comprise searching for another object within at least one of (i) the first focus range of the imaging sensor and/or (ii) the fourth focus range of the second imaging sensor.

In a variation of this example embodiment, the position within the overlap region may be further within (i) the first focus range of the imaging sensor and/or (ii) the fourth focus range of the second imaging sensor. In a variation of this example embodiment, the computer-implemented method may comprise adjusting the focus of the imaging sensor to the first focus range. In a variation of this example embodiment, the computer-implemented method may comprise adjust the focus of the second imaging sensor to the fourth focus range. In a variation of this example embodiment, the computer-implemented method may comprise determining that the object by-passed the indicia scanner. In a variation of this example embodiment, the computer-implemented method may comprise generating an alert signal that indicates that the object by-passed the indicia scanner.

In a variation of this example embodiment, the computer-implemented method may comprise adjusting the focus of the imaging sensor by switching between the first imaging sensor and the second imaging sensor.

In a variation of this example embodiment, the computer-implemented method may comprise increasing or decreasing a brightness, increasing or decreasing an exposure length, increasing or decreasing a gain, increasing or decreasing a zoom, increasing or decreasing a field-of-view angle, increasing or decreasing a readout limit, or switching between imaging light sources.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates a block diagram of an example scanner system, according to example embodiments of the present disclosure.

FIG. 2A illustrates a side view of an example scanner system and an imaging field-of-view, according to example embodiments of the present disclosure.

FIG. 2B illustrates a side view of an example scanner system and a controlled readout field-of-view, according to example embodiments of the present disclosure.

FIG. 3 illustrates a top-down view of an example scanner system with overlapping imaging fields-of-view, according to example embodiments of the present disclosure.

FIG. 4 illustrates a perspective view of an example scanner system with overlapping imaging fields-of-view, according to example embodiments of the present disclosure.

FIG. 5 illustrates an example flowchart for switching between focus ranges of one or more imaging fields-of-view using an example scanner system, according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Systems and methods are provided herein for operating imaging systems with a plurality of focus ranges. The use of imaging systems, or computer vision systems, has become widespread across various industries, such as retail stores, fast food restaurants, and manufacturing. In retail stores, for example, imaging systems can quickly and confidently identify products at checkout to provide a more efficient customer experience. In addition, imaging systems can deter or prevent shoplifting (e.g., ticket switching, scan skipping, scan avoidance, etc.) by comparing images of scanned products with the scanned barcode (or other product indicia) information to ensure the physical product matches the barcode. Imaging systems can be setup at self-checkout stations to monitor each stage of the self-checkout process. For example, cameras can monitor incoming items (e.g., from a conveyor belt, a shopping cart, etc.), identify each item as its product indicia (e.g., label, barcode, etc.) is scanned, and ensure that each item in the bagging area correctly matches information from a decoded product indicia.

Conventional self-checkout vision systems often face challenges due to their use of fixed focus lenses. One drawback to conventional fixed focus lens systems is they are configured to focus on products within a single or fixed depth of focus which can make it difficult to capture clear images of products at different stages (or locations) of the self-checkout process. For example, if a product is not positioned at the optimal distance from the camera, the image may be out of focus making the product in the image unidentifiable. Conventional top-down fixed focus lens systems (e.g., where the camera(s) have a top-down view of various locations along the self-checkout station) can still struggle with achieving a single fixed depth of focus that can effectively cover all areas of a self-checkout station. For example, differences in heights between a conveyor belt, shopping cart, in-counter product scanner, and/or bagging area of the self-checkout station may each require a different depth of focus to capture in-focus images at each location. Additionally, or alternatively, if a customer moves a product through a field-of-view of a fixed focus camera too quickly, this can result in unclear images due to motion blur and/or slow system response times that capture images after a product exits the fixed focus range. Conventional autofocus systems suffer from similar limitations and drawbacks. One drawback to conventional autofocus systems is that they are too slow to effectively react to fast moving objects. For example, conventional autofocus systems often fail to capture products (or capture unclear images of products) being moved through the field-of-view of an autofocus camera too quickly. Unclear images can lead to misidentification of products which may require additional time (and/or employee assistance) to correct (e.g., by rescanning). This not only can frustrate customers but also undermines the benefits of efficiency, speed, and convenience that self-checkout systems are meant to provide. Accordingly, there exists a need for imaging systems that can react fast enough to detect the focus range of a subject (e.g., product, person, face, etc.) and/or adjust one or more cameras (or imaging sensors) to the necessary focus range before a fast moving subject (e.g., moving equal to or greater than 100 inches per second, or another number) is out of focus and/or outside of the field-of-view of the one or more cameras (or imaging sensors).

In contrast to the conventional systems and techniques described above, improved imaging systems configured with a plurality of focus ranges and techniques for operating these improved imaging systems are described herein. The present disclosure sets forth systems, methods, and apparatuses that, among other things, provide improved methods for adjusting the depth of focus of one or more cameras (and/or imaging sensors) between a plurality of fixed focus ranges. Systems, methods, and apparatuses of the present disclosure seek to solve problems associated with conventional self-checkout vision systems stations. For example, scanner systems (as described herein) may utilize detection sensors to quickly detect the presence (and/or location) of an object relative to an imaging system and, in response, the imaging system may select (and/or switch to) an optimal fixed focus range (e.g., from among a plurality of fixed focus ranges). One advantage of the improved imaging systems (described herein) is that such systems can capture clear images of fast moving products (e.g., moving equal to or greater than 100 inches per second, or another number) as the products move throughout the various locations of a self-checkout station. Another advantage of the improved imaging systems (described herein) is that such systems may be configured to switch between a plurality of (e.g., fixed) focus ranges. It should be appreciated that switching between a plurality of (e.g., fixed) focus ranges may be (i) more flexible than utilizing a single fixed focus range of conventional fixed focus lens systems, and (ii) faster than adjusting a variable depth of focus camera using conventional autofocus systems.

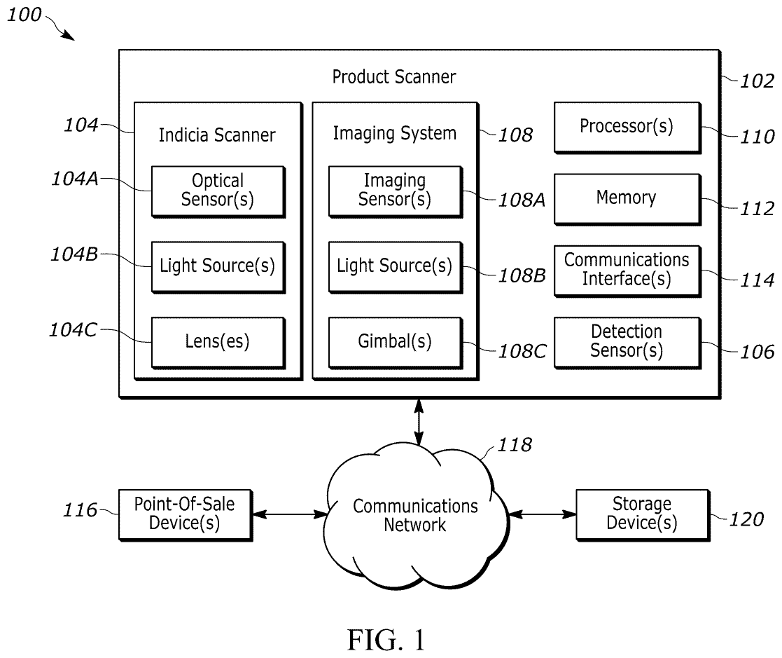

FIG. 1 illustrates a block diagram of an example scanner system, according to example embodiments of the present disclosure. As shown, a scanner system 100 comprises a product scanner 102, point-of-sale device(s) 116, a communications network 118, and storage device(s) 120. In some examples, the scanner system 100 may comprise a self-checkout station (or the like) configured to scan one or more products and identify each product (e.g., using a barcode, vision systems, etc.) to one or more point-of-sale devices that can facilitate the purchase of the product(s).

In the depicted example, the product scanner 102 may be one or more of a fixed product scanner (e.g., an in-counter scanner, biotic scanner, etc.), a handheld product scanner (e.g., an inventory scanner gun, etc.), and/or the like as described herein. As illustrated, the product scanner 102 may be communicatively coupled, via the communications network 118, to one or more of the point-of-sale device(s) 116 and/or the storage device(s) 120. The product scanner 102, as shown, comprises an indicia scanner 104, detection sensor(s) 106, an imaging system 108, processor(s) 110, memory 112, and communications interface(s) 114.

The indicia scanner 104, as shown, may be any optical scanner capable of reading data from a product indicia tag or label (e.g., barcode, Universal Product Code (UPC), Price Look-up Code (PLU), Quick-Response (QR) code, and/or the like). For example, the indicia scanner 104 may be an optical barcode scanner (e.g., Charge-Coupled Device (CCD) readers, etc.) configured to read printed barcodes (and/or the like) using a light source (e.g., laser, Light Emitting Diode (LED), etc.) and transmit data decoded from the barcode (and/or the like) to a computer (e.g., point-of-sale device(s) 116 or any other computing device described herein). As illustrated, the indicia scanner 104 comprises optical sensor(s) 104A, light source(s) 104B, and lens(es) 104C. The optical sensor(s) 104A may be any optical sensor described herein including, without limitation, one or more of a photodiode, a Charge-Coupled Device (CCD) sensor, a Complementary Metal-Oxide-Semiconductors (CMOS) sensor, a laser diode, and/or any other sensor for decoding a product indicia. The optical sensor(s) 104A may be configured to decode information (or data), for example, from light reflected off of the product indicia (e.g., QR code, etc.). The light source(s) 104B may be any light source described herein including, without limitation, one or more of a laser diode, an LED, an infrared bulb, and/or the like. The light source(s) 104B may be configured to direct light onto a product indicia (e.g., barcode) to cause the surface of the product indicia to reflect light back toward a sensor (e.g., optical sensor(s) 104A) of the indicia scanner 104. The lens(es) 104C may be any protective lens described herein including, without limitation, one or more of a glass lens, a polyacrylic lens, and/or any other transparent covering. The lens(es) 104C may be configured to allow light to pass from light source(s) 104B to a product indicia and/or allow reflected light to pass from the product indicia to optical sensor(s) 104A. The lens(es) 104C may be configured to protect (and/or separate) the interior components (e.g., optical sensor(s) 104A, light source(s) 104B, lens(es) 104C, electrical connections, circuit boards, etc.) of the indicia scanner 104 from the hazards of the exterior environment (e.g., dirt, dust, impacts, etc.).

The detection sensor(s) 106, as shown, may be any circuitry capable of detecting and/or locating an object using electromagnetic waves, near-infrared light, laser beams, sound waves, and/or the like as described herein. Example detection sensors may comprise, without limitation, one or more of a three-dimensional (3D) sensor, a Time-of-Flight (ToF) sensor, an infrared (IR) sensor (e.g., an IR light curtain, a Passive Infrared (PIR) sensor, etc.), a parallax sensor (e.g., for detecting parallax between two or more imaging sensors and/or cameras), an ultrasonic sensor, and/or any other sensor(s) described herein for detecting an object and/or a distance to an object. In some examples, the detection sensor(s) 106 may comprise a 3D sensor configured to capture spatial data (e.g., detect objects, locations, distances, etc.) using light (e.g., near-infrared, etc.) reflection and/or geometric equations to measure the length, width, and/or depth of objects to map, at least in part, a three-dimensional environment. In some examples, the detection sensor(s) 106 may comprise a ToF sensor configured to measure one or more distances to an object by emitting an infrared light beam and/or calculate the flight time for the beam of light to travel to, and/or return from, a surface of an object (e.g., the beam of light may travel to an object, reflect off of the object, and return to the ToF sensor). In some such examples, the detection sensor(s) 106 may comprise a timer (e.g., system clock, etc.) for measuring a time interval between when a beam of light is emitted from the sensor and when the reflection of the beam of light is detected by the sensor. In some examples, the detection sensor(s) 106 may comprise an IR sensor (e.g., an IR light curtain, etc.) configured to determine the presence of an object and/or a distance from the sensor to an object by emitting an infrared light beam and/or detecting the angle of the reflected light off of an object. In some such examples, the IR sensor may use triangulation techniques to determine the location of an object relative to the IR sensor and/or measure the distance to the object relative to the IR sensor. In some examples, the detection sensor(s) 106 may comprise a parallax sensor comprising software (e.g., computer program instructions, code, etc.) and/or hardware (e.g., Application-Specific Integrated Circuits (ASICs), System on a Chip (SoC), etc.) that leverages two or more imaging sensors (e.g., of the imaging system 108) to determine (or calculate) a parallax between the two or more imaging sensors and/or cameras. In some examples, the detection sensor(s) 106 may comprise a parallax sensor comprising two or more sensors as described herein for detecting the presence and/or distance to an object. For example, a parallax sensor may comprise two or more of an ultrasonic sensor, IR sensor and/or PIR sensor, and/or the like for detecting a shift in the position of an object observed from at least two viewpoints (i.e., from two or more offset sensors). It should be appreciated that shift in the position of an object observed from at least two viewpoints is known as parallax. Parallax may be a displacement or difference in the observable position of an object viewed along two different lines of sight and may be measured by the angle (or the half-angle) of inclination between those two lines.

The imaging system 108, as shown, may be any computer vision system configured to capture and/or interpret images and/or video content. For example, the imaging system 108 may be a computer vision system for recording images of a product during checkout, comparing those images of the product to a machine learning database (e.g., training data stored on storage device(s) 120, etc.), and/or identifying the product in the recorded images. In some examples, the imaging system 108 may leverage the indicia scanner 104 and/or the point-of-sale device(s) 116 to determine whether the product in the recorded images matches a product associated with a product indicia (e.g., barcode, price tag, etc.). As illustrated, the imaging system 108 comprises the imaging sensor(s) 108A, light source(s) 108B, and gimbal(s) 108C. In some examples, the imaging system 108 may comprise (or replace), at least in part, the indicia scanner 104 of the product scanner 102. Additionally, or alternatively, the imaging system 108 may perform, at least in part, one or more operations (or functions) described herein in connection with the indicia scanner 104. For instance, the imaging system 108 may capture indicia data from a product indicia by capturing an image (or video) of the product indicia using the imaging sensor(s) 108A. In some examples, the imaging system 108 may use one or more machine vision applications (or the like) to decode (or read) the product indicia (e.g., based, at least in part, on image and/or video data).

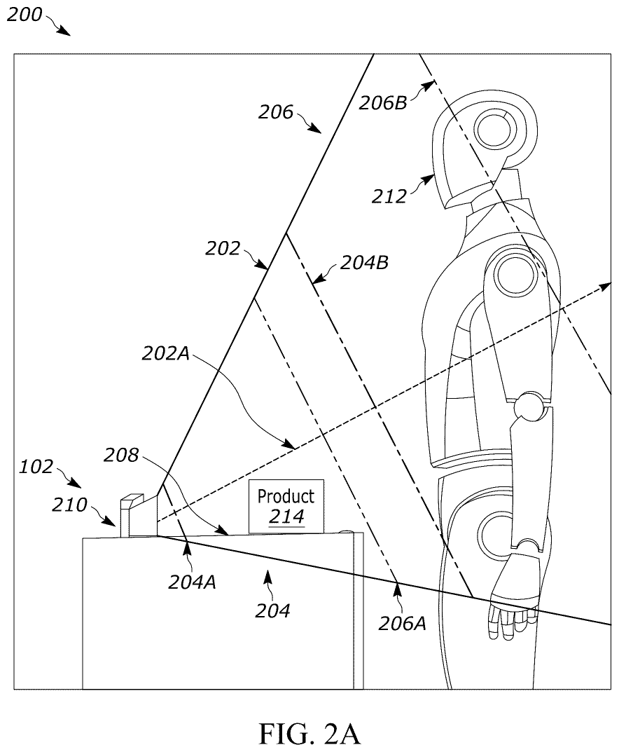

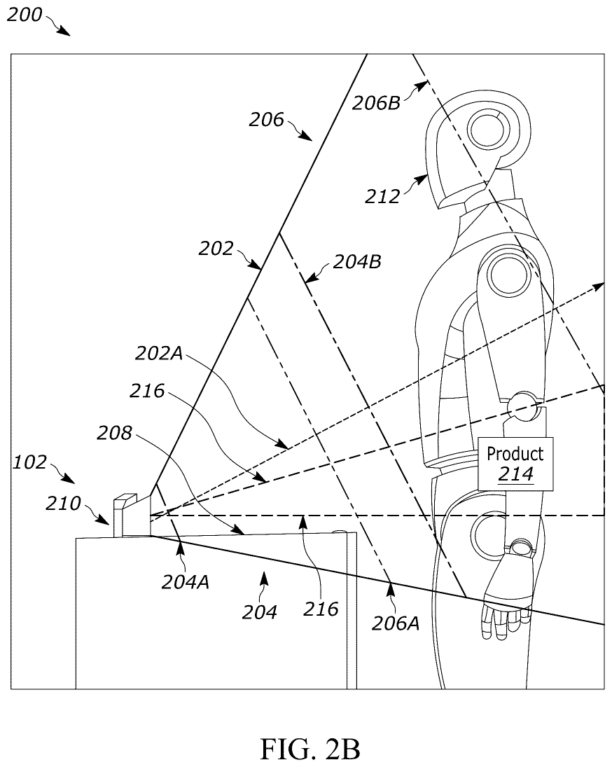

The imaging sensor(s) 108A may be any camera, imager, image sensor, and/or the like as described herein for recording still images and/or video content. In some examples, the imaging sensor(s) 108A may comprise (or define) one or more imaging fields-of-view (e.g., imaging field-of-view 202 as described below in connection with FIG. 2A.). In some examples, the imaging system 108 may comprise a machine learning algorithm for detecting, identifying, and/or tracking objects in recorded images and/or video. In some such examples, the machine learning algorithm (e.g., object detection algorithm, etc.) may leverage processor(s) 110 and/or computer program instructions stored on memory 112 to perform one or more operations described herein in connection with the imaging system 108. In some examples, the imaging sensor(s) 108A may perform one or more operations (or functions) described herein in connection with the optical sensor(s) 104A.

The light source(s) 108B may be any light source described herein including, without limitation, one or more of a laser diode, an LED, a light bulb, and/or any other device for emitting visual, infrared, or any other type of light. The light source(s) 108B may be configured to direct light onto an object to illuminate the object during image capture and/or video recording (e.g., by a camera, etc.). In some examples, the light source(s) 108B may be light sources (e.g., sunlight, skylights, store lighting, etc.) external to, and/or distinct from, the imaging system 108.

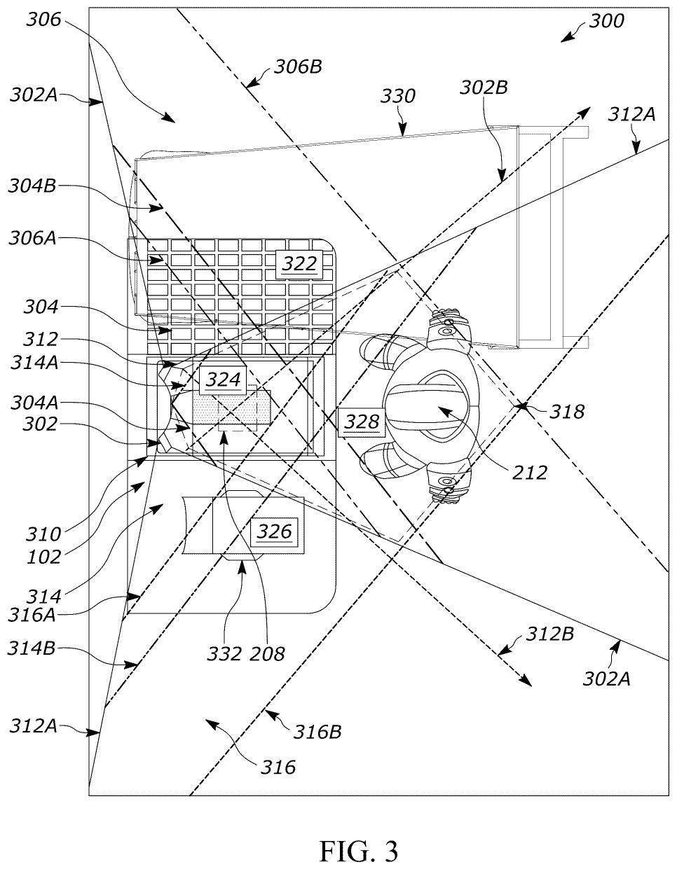

The gimbal(s) 108C may be any electrical and/or mechanical device for stabilizing a camera while in motion. In some examples, the gimbal(s) 108C may comprise one or more of a 2-axis gimbal, a 3-axis gimbal, a motor (e.g., stepper motor, servomotor, etc.), a gyroscope sensor, a counterweight, a lever arm, an imaging sensor (or camera) mounting platform, and/or the like as described herein for stabilizing a camera during filming to capture (or record) smooth and/or steady video data (and/or still image data). In some examples, the imaging system 108 may leverage the detection sensor(s) 106 (and/or object detection algorithms and/or object tracking algorithms) to follow (or track) an object. In some such examples, the imaging system 108 may stabilize and/or move the imaging sensor(s) 108A (e.g., one or more cameras) using the gimbal(s) 108C. In some examples, the gimbal(s) 108C may use three motors (or any other number) disposed along one or more axes (e.g., X-axis, Y-axis, Z-axis) to facilitate panning, tilting, and/or rolling of the imaging sensor(s) 108A in order to counteract unwanted movements. In some such examples, the motors of the gimbal(s) 108C may be controlled by gyroscopic sensors (and/or accelerometers) that detect any motion and adjust the camera's position accordingly. In some examples, the gimbal(s) 108C may be configured to move along a predefined path. For example, the gimbal(s) 108C may be configured to move (or pan) a camera from left to right (and back) along a 180° (arcing) path to capture products moving from a shopping cart to a bagging area (e.g., as shown in FIG. 3).

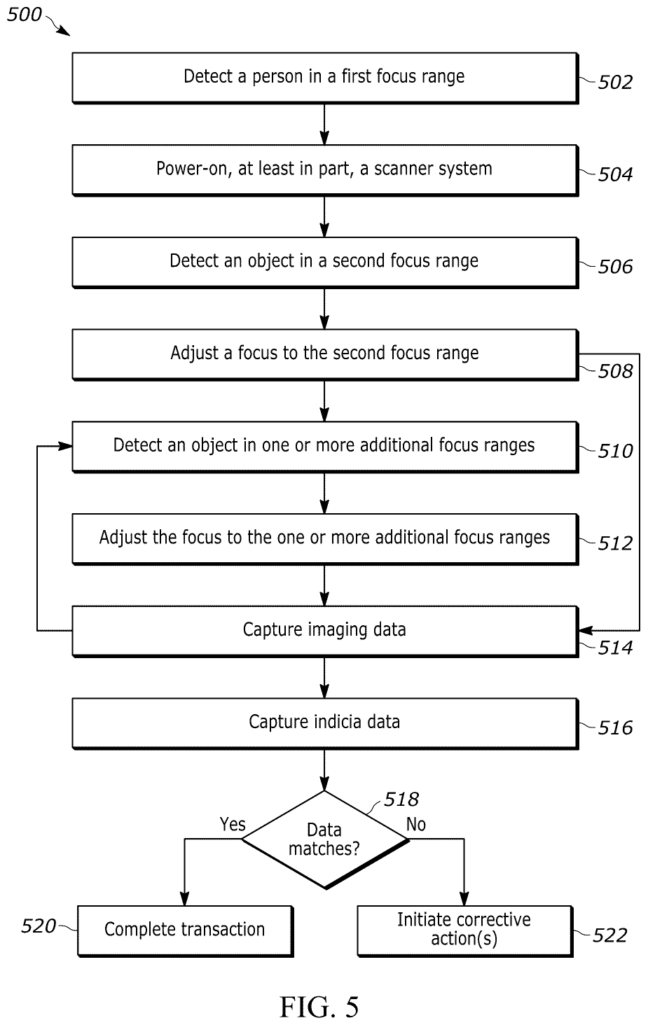

The processor(s) 110, as shown, may be any processor or Central Processing Unit (CPU) of a computing device. The processor(s) 110 may comprise a plurality of processors and/or one or more processors having multiple cores. In some examples, the processor(s) 110 may comprise one or more cores of different types, such as an application processor unit, Graphic Processing Unit (GPU), and/or the like. In some examples, the processor(s) 110 may comprise one or more of a microcontroller, a microprocessor, a digital signal processor, and/or any other processing units described herein. Alternatively, or additionally, the functionality described herein (e.g., in connection with the process 500 as illustrated in FIG. 5) may be performed, at least in part, by one or more hardware logic components associated with the processor(s) 110. For example, and without limitation, illustrative types of hardware logic components associated with the processor(s) 110 that may be used to perform the operations described herein may include Field-Programmable Gate Arrays (FPGAs), Application-Specific Integrated Circuits (ASICs), Application-Specific Standard Products (ASSPs), System on a Chip (SoC), Complex Programmable Logic Devices (CPLDs), and/or the like. In some examples, the processor(s) 110 may comprise on-board (or local) memory, which also may store at least one set of program code, program instructions, firmware, software, an Operating System (OS), and/or the like.

The memory 112, as shown, may be any volatile memory, non-volatile memory, removable media device, non-removable media device, tangible machine-readable medium, non-transitory machine-readable medium, and/or machine-readable storage device for storage of electronic data (e.g., computer-readable software instructions, data structures, program code, firmware, software, and/or any other data described herein). The memory 112 may comprise Random Access Memory (RAM), Read-Only Memory (ROM), Electrically Erasable Programmable Read-Only Memory (EEPROM), flash memory, a Compact Disc (CD), a Digital Versatile Disk (DVD), magnetic disk storage, and/or any other electronic storage device which can be used to store electronic data. The memory 112 may be implemented as Computer-Readable Storage Media (CRSM), which may comprise any available physical media accessible by the processor(s) 110 to execute instructions stored on the memory. In some examples, a CRSM may include RAM and/or flash memory (e.g., NAND flash memory, NOR flash memory, etc.). The memory 112 may be any example of non-transitory computer-readable storage media. The memory 112 may store at least one set of program code, program instructions, firmware, software, an Operating System (OS), and/or any other data to implement the functionality and/or operations described herein (e.g., in connection with the process 500 as illustrated in FIG. 5) for various example systems. In some examples, the memory 112 may store one or more parameters, settings, and/or command instructions for controlling the product scanner 102 (e.g., indicia scanner 104, imaging system 108, detection sensor(s) 106, etc.) to perform one or more operations as described herein.

In the depicted example, the communications interface(s) 114 may be any communications hardware, software, and/or protocols that allow a computing device (e.g., the product scanner 102) to communicate with another computing device (e.g., via the communications network 118). For example, the communications interface(s) 114 may facilitate communication between the product scanner 102 and point-of-sale device(s) 116 and/or storage device(s) 120. In some examples, the communications interface(s) 114 comprise a Wi-Fi circuit (e.g., Dual-band antenna, Tri-band antenna, etc.), ZigBee circuit, Bluetooth circuit (e.g., Bluetooth 5.2, Bluetooth Low Energy (BLE), etc.), and/or any other communications protocol, hardware, software, and/or firmware. The communications interface(s) 114 may permit communication with remote device(s), such as mobile devices (e.g., smart phones, mobile scanners, etc.), systems (e.g., cloud services, remote servers, etc.), and/or the like. The communications interface(s) 114 may leverage any type of communications network (e.g., communications network 118), including data and/or voice network, and may be implemented using wired infrastructure (e.g., cable, CAT5, fiber optics, etc.), a wireless infrastructure (e.g., radio frequency, cellular, microwave, satellite, etc.), and/or other communication connection technologies. In some examples, inbound data may be routed through the communications interface(s) 114 before being directed to the processor(s) 110. In some examples, outbound data from the processor(s) 110 may be routed through the communications interface(s) 114 before being directed to a communications network (e.g., communications network 118). The communications interface(s) 114 may therefore receive inputs, such as data, from the processor(s) 110 and/or any other component described herein. For example, the communications interface(s) 114 may be configured to transmit data to, and/or receive data from, one or more network devices (e.g., Wi-Fi routers, etc.). In some examples, the communications interface(s) 114 may act as a conduit for data communicated between various internal systems (or components) of the product scanner 102 and the processor(s) 110.

In the depicted example, the communications network 118 may be the Internet, an intranet, and/or any other examples of a communications network as described herein for sending and/or receiving data between two or more computing devices (e.g., product scanner 102, point-of-sale device(s) 116, etc.). The communications network 118, as shown, may comprise one or more of a Wi-Fi circuit (e.g., Wi-Fi router), ZigBee circuit, Bluetooth circuit (e.g., Bluetooth 5.2 chip, Bluetooth Low Energy (BLE) chip, etc.), LTE circuit, and/or any other communications protocol, hardware, software, and/or firmware. In some examples, the communications network 118 may permit remote communication between two or more computing devices including, without limitations, servers (e.g., storage device(s) 120, etc.), computers, mobile devices, remote systems and services (e.g., cloud services, webservices, etc.), and/or the like as described herein. In some examples, the communications network 118 may be representative of any type of communication network(s), data networks, voice network(s), and/or the like. In some examples, the communications network 118 may be implemented using wired infrastructure (e.g., cable, CAT5, fiber optics, etc.), a wireless infrastructure (e.g., radio frequency, cellular, microwave, satellite, etc.), one or more network devices (e.g., Wi-Fi routers, base stations, relay servers, etc.), and/or any other communications connection technologies. In some examples, the communications network 118 may comprise one or more communications channels, tunnels, Virtual Private Networks (VPNs), and/or the like. In some examples, the communications network 118 may be implemented using encryption techniques (e.g., end-to-end encryption, etc.).

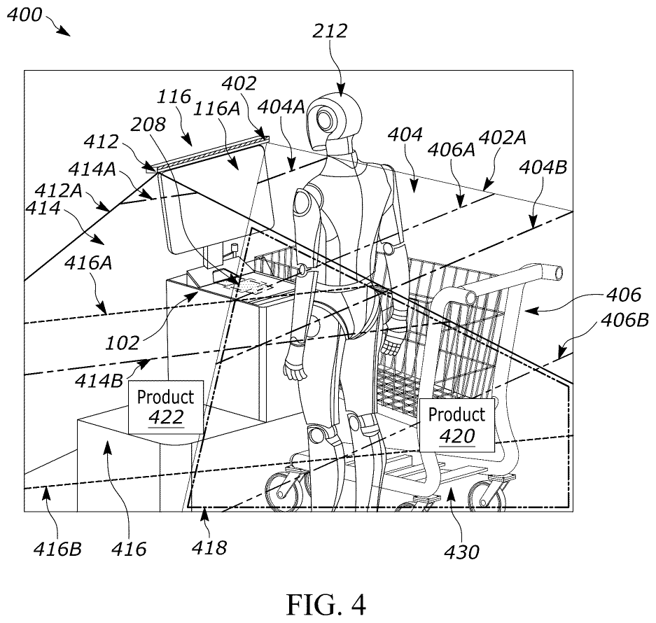

In the depicted example, the point-of-sale device(s) 116 may be any system for processing a sales transaction. For example, the point-of-sale device(s) 116 may be a computing device communicatively coupled to one or more of a cash register, a touchscreen monitor (e.g., the display device 116A as shown in FIG. 4), a payment terminal (e.g., card reader, cash recycler, etc.), a receipt printer, and/or the like as described herein. In some examples, the point-of-sale device(s) 116 may comprise a self-checkout point-of-sale system. In some such examples, the point-of-sale device(s) 116 may comprise, at least in part, the product scanner 102 as described above.

In the depicted example, the storage device(s) 120 may be any computing device and/or non-transitory machine-readable medium as described herein that is configured to manage and/or store datasets (e.g., training data, etc.), features, labels, models, and/or performance metrics for a machine learning model (e.g., vision system machine learning model(s), machine vision application(s), and/or algorithm(s)). As shown, the storage device(s) 120 comprises one or more of a database, data set, data table, and/or the like as described herein. In some examples, the database(s) (or the like) may be any database comprising a structured repository of data for facilitating the training and/or evaluation of machine learning models and/or algorithms. In some examples, the database(s) may store labeled and/or unlabeled data and, in such examples, may further enable the iterative refinement of models and/or algorithms through supervised, unsupervised, and/or reinforcement learning techniques. Additionally, or alternatively, the database(s) may incorporate mechanisms for data preprocessing (e.g., deletion of redundant data, etc.), feature extraction, and/or real-time (or near-real-time) updates (e.g., using data collected from live customer checkouts, data comprising a trusted data flag or marker, etc.) to ensure optimal performance and/or accuracy of the machine learning model(s) and/or algorithm(s). In some examples, the storage device(s) 120 may facilitate backup and/or additional data storage for the memory 112.

In some examples, the storage device(s) 120 may comprise a computer vision machine learning model, algorithm, and/or dataset for identifying objects based, at least in part, on video (and/or any other imaging data). In some examples, the storage device(s) 120 may comprise a lookup table associated with one or more of a barcode, Universal Product Code (UPC), Price Look-up Code (PLU), and/or any other product indicia described herein. In some examples, the storage device(s) 120 may comprise training data for training one or more computer vision machine learning model(s) and/or algorithm(s). For example, the storage device(s) 120 may comprise a product image database comprising images of products associated with product indicia (e.g., barcode data, etc.) that may be used as training data to associate images, pictures, and/or video of an object (e.g., a product, etc.) with one or more known products (e.g., products previously scanned and identified, such as during inventorying). In some examples, employees may compile and/or update (e.g., add or remove data, correct errors, etc.) a product image database when taking inventory, setting up the imaging system 108, and/or training (and/or retraining) the imaging system 108 to identify new products. In some examples, only data flagged from a trusted source may be added to the product image database. For example, products scanned by customers may be compared to the product image database to identify one or more products, however, data generated when customers scan products may not be added as training data to the product image database (e.g., because the products may have been tampered with prior to being scanned).

FIG. 2A illustrates a side view of an example scanner system and an imaging field-of-view, according to example embodiments of the present disclosure. As depicted in FIG. 2A, the scanner system 200 may comprise, at least in part, the scanner system 100 and/or the like as described herein. The scanner system 200, as shown, comprises the product scanner 102, an imaging field-of-view 202, a central axis 202A, a near-stage focus range 204 between a lower limit 204A and an upper limit 204B, a far-stage focus range 206 between a lower limit 206A and an upper limit 206B, an indicia scan region 208, and a bioptic scanner 210. As shown in the depicted example, the scanner system 200 may be a self-checkout station (or the like) configured for a customer (e.g., person 212) to scan one or more products (e.g., product 214) and/or identify each product (e.g., using a barcode, imaging data, etc.) to one or more point-of-sale devices (e.g., point-of-sale device(s) 116) that can facilitate the purchase of the product(s). In some such examples, the scanner system 200 may comprise the point-of-sale device(s) 116, as described above for FIG. 1, to facilitate sales and/or financial transactions.

The product scanner 102, as shown, may comprise a bioptic scanner 210. In the depicted example, the bioptic scanner 210 may comprise a housing that extends above the counter of the self-checkout station. In some examples, the housing of the bioptic scanner 210 may comprise at least in part the indicia scanner 104, the imaging system 108, and/or the like as described herein. For example, the bioptic scanner 210 may comprise (or house) an imaging sensor (e.g., imaging sensor(s) 108A) and/or a camera of the imaging system 108 configured (or positioned) to produce an imaging field-of-view (e.g., imaging field-of-view 202) as illustrated. In addition, the bioptic scanner 210 may comprise (or house) an optical sensor (e.g., optical sensor(s) 104A) of the indicia scanner 104 configured (or positioned) to decode product indicia (e.g., barcodes, etc.) as the products (e.g., product 214) pass over the indicia scan region 208. In some examples, the indicia scanner 104 may comprise two or more optical sensor(s) 104A, such as one or more disposed within the bioptic scanner 210 and one or more disposed under the indicia scan region 208 (e.g., an in-counter optical sensor).

The imaging field-of-view 202, as shown, may represent a portion of an environment around the product scanner 102 that is visible to an imaging sensor (e.g., imaging sensor(s) 108A) and/or a camera of the imaging system 108. In some examples, a size and/or shape of the imaging field-of-view 202 may be proportional to a focal length of a lens and/or an imaging sensor size. For example, shorter focal length lenses (e.g., wide-angle lenses, etc.) may produce a larger (or wider) imaging field-of-view (e.g., the imaging field-of-view 202 emanating from the bioptic scanner 210 with a wider angle than illustrated). Additionally, or alternatively, larger image sensors (e.g., 53.0 mm×40.2 mm, etc.) may produce a larger (or wider) imaging field-of-view and smaller image sensors (e.g., 6.17 mm×4.55 mm, etc.) may produce a smaller (or narrower) imaging field-of-view. It should be understood that a larger field-of-view can capture relatively more imaging data and/or produce larger image frames (e.g., larger pictures) and a smaller field-of-view can capture relatively less imaging data and/or produce smaller image frames (e.g., smaller pictures). In some examples, the imaging system 108 may limit (or control) a resolution of an image sensor to produce a partial frame readout and/or a full frame readout of an image sensor (e.g., imaging sensor(s) 108A) to produce a smaller image frame focusing on a particular subject (as will be described below in connection with FIG. 2B). It should be appreciated that a readout limit may be a resolution of an image (and/or frame) generated or transmitted from an imaging sensor.

In the depicted example, the imaging field-of-view 202 may comprise (or define) the central axis 202A. In some examples, the central axis 202A may represent an imaginary line that runs (e.g., perpendicularly, axially, etc.) through the center of the imaging sensor (e.g., imaging sensor(s) 108A) and/or a camera lens. In some such examples, the central axis 202A may extend outward in the direction of the imaging field-of-view (e.g., the view or perspective of a camera or the like). In some examples, the imaging system 108 may utilize the central axis 202A for aligning and focusing a camera (or the like), such as by ensuring that a subject (e.g., product, person, face, etc.) is properly centered within the frame. For example, the central axis 202A may be oriented (e.g., during setup, using gimbal(s) 108C, etc.) to, at least in part, intersect with one or more subjects (e.g., the person 212 and/or the product 214 as shown) to ensure that they are, at least partially, within the imaging field-of-view 202. In some examples, the central axis 202A may extend perpendicularly from the imaging sensor. In some examples, the imaging system 108 (or the like) may reference the central axis 202A to measure a distance from an imaging sensor to one or more of a subject, a focus range, a lower limit of a focus range, an upper limit of a focus range, and/or the like as described herein. In some examples, the imaging system 108 may use the angle (and/or distance) between two central axes to determine one or more of a parallax, a distance, and/or the like as described herein.

In the depicted example, the imaging field-of-view 202 comprises (or defines) a near-stage focus range 204, a lower limit 204A, and/or an upper limit 204B. As shown, the near-stage focus range 204 comprises (or defines) the lower limit 204A and the upper limit 204B. For example, the near-stage focus range 204 may include any or all portions of the imaging field-of-view 202 between and/or including the lower limit 204A and the upper limit 204B. In some examples, a lower boundary (e.g., the lower limit 204A) of a first focus range (e.g., the near-stage focus range 204) may be disposed along the central axis 202A at a lower (or shorter) distance from an imaging sensor (e.g., imaging sensor(s) 108A). In some such examples, an upper boundary (e.g., the upper limit 204B) of a first focus range (e.g., the near-stage focus range 204) may be disposed along the central axis 202A at an upper (or longer) distance from the imaging sensor (e.g., imaging sensor(s) 108A).

In the depicted example, the imaging field-of-view 202 comprises (or defines) a far-stage focus range 206, a lower limit 206A, and/or an upper limit 206B. As shown, the far-stage focus range 206 comprises (or defines) the lower limit 206A and the upper limit 206B. For example, the far-stage focus range 206 may include any or all portions of the imaging field-of-view 202 between and/or including the lower limit 206A and the upper limit 206B. In some examples, a lower boundary (e.g., the lower limit 206A) of a second focus range (e.g., the far-stage focus range 206) may be disposed along the central axis 202A at a lower (or shorter) distance from an imaging sensor (e.g., imaging sensor(s) 108A). In some such examples, an upper boundary (e.g., the upper limit 206B) of a second focus range (e.g., the far-stage focus range 206) may be disposed along the central axis 202A at an upper (or longer) distance from the imaging sensor (e.g., imaging sensor(s) 108A). In some examples, an imaging field-of-view (e.g., imaging field-of-view 202, etc.) may comprise (or define) a plurality of additional focus ranges (e.g., a 3^{rd} focus range, a 4^{th} focus range, . . . , an N^{th} focus range) with respective upper and lower boundaries (or limits) at various distances along a central axis (e.g., central axis 202A, etc.) as described above.

In some examples, the near-stage focus range 204 may overlap, at least in part, with the far-stage focus range 206. In some such examples, the overlap region between the near-stage focus range 204 and the far-stage focus range 206 may include any or all portions of the imaging field-of-view 202 between and/or including the lower limit 206A (of the far-stage focus range 206) and the upper limit 204B (of the near-stage focus range 204). It should be appreciated that overlapping focus ranges may be advantageous (or beneficial) so that subjects (e.g., items, people, etc.) may not be missed (or lost) by an imaging system when moving (or traveling) between two or more focus ranges. For example, the imaging system 108 may switch from the far-stage focus range 206 to the near-stage focus range 204 (and/or vice versa) while a subject is in the overlap region in order to (e.g., continuously) maintain an in-focus image of the subject.

As shown in FIG. 2A, various focus ranges (e.g., near-stage focus range 204, far-stage focus range 206) may be configured, at least in part, within the imaging field-of-view 202 to cause (or trigger) one or more respective responses from the scanner system 200. For example, when not providing service to a customer the scanner system 200 may enter a low-power state (e.g., 30 seconds, or another number, after a sales transaction has completed without receiving additional user inputs) to conserve energy. In the low-power state the imaging system 108 of the product scanner 102 may remain, at least in part, active to monitor one or more focus ranges for the presence of a subject. For example, the imaging system 108 may use person (and/or facial) detection algorithms (or models) to monitor the far-stage focus range 206 for a person (e.g., the person 212, a customer, an employee, a face, etc.). In such examples, when the person 212 enters the far-stage focus range 206 of the imaging field-of-view 202, then the imaging system 108 may generate an activation (or power-on) signal that is configured to power-on one or more components of the scanner system 200 (e.g., indicia scanner 104, a computing device, touchscreen monitor, etc.). For instance, the product scanner 102 and/or the point-of-sale device(s) 116 may turn-on (or power-on) in response to the person 212 entering, at least in part, the far-stage focus range 206. In some such examples, the imaging system 108 may transmit the activation signal (e.g., using communications interface(s) 114, etc.) to the one or more components of the scanner system 200 that require activation (e.g., to complete a sales transaction with a customer).

In some examples, upon receipt of an activation signal (e.g., using communications interface(s) 114, etc.), the one or more components of the scanner system 200 may power-on but may remain in a stand-by mode (e.g., power-saving mode, sleep mode, etc.) to conserve energy and/or to provide the customer with an improved sales interaction. For example, when the person 212 enters the far-stage focus range 206 (as described above), the indicia scanner 104 may power-on but remain, at least in part, inactive, such as by dimming or not activating the light source(s) 104B (or other forms of illumination). It should be appreciated that by dimming or not activating the light source(s) 104B the scanner system 200 may advantageously conserve electrical energy and/or improve a self-checkout experience for a customer (e.g., by preventing unnecessary illumination from irritating a customer's eyes or interfering with their vision).

In some examples, the imaging system 108 may use object detection algorithms (or models) to monitor the near-stage focus range 204 for a product (e.g., the product 214, a package, a piece of produce (fruit, a vegetable, etc.), or the like). In such examples, when the product 214 enters the near-stage focus range 204 of the imaging field-of-view 202, then the imaging system 108 may generate a wake signal that is configured to wake-up one or more components of the scanner system 200 (e.g., indicia scanner 104, a computing device, touchscreen monitor, etc.). For instance, the product scanner 102 (or the like) may be in a stand-by mode (e.g., power-saving mode, sleep mode, etc.), as described above, and may wake-up (e.g., exit a sleep mode, etc.) in response to the product 214 entering, at least in part, the near-stage focus range 204. In some such examples, the imaging system 108 may transmit the wake signal (e.g., using communications interface(s) 114, etc.) to the one or more components of the scanner system 200 that are required to wake-up to complete an operation (e.g., to complete a sales transaction with a customer). For example, the imaging system 108 may detect the product 214 in the near-stage focus range 204 and, in response, the scanner system 200 (or the like) may wake-up the product scanner 102 to facilitate decoding of a product indicia associated with the product 214. In some examples, the scanner system 200 (or the like) may block (or prevent) the optical sensor(s) 104A and/or the light source(s) 104B from decoding a product indicia (e.g., barcode, etc.) if a product (e.g., product 214) is not detected in the near-stage focus range 204 (or the like). In some examples, the scanner system 200 (or the like) may allow (or permit) the optical sensor(s) 104A and/or the light source(s) 104B to decode a product indicia (e.g., barcode, etc.) if a product (e.g., product 214) is detected in the near-stage focus range 204 (or the like).

FIG. 2B illustrates a side view of an example scanner system and a controlled readout field-of-view, according to example embodiments of the present disclosure. As shown, FIG. 2B illustrates the scanner system 200 (as described above in connection with FIG. 2A) with the addition of a controlled readout field-of-view 216 (e.g., representative of a readout limit). As shown, in the depicted example, the imaging field-of-view 202 may comprise (or define) the controlled readout field-of-view 216. In some examples, the imaging system 108 may expose an imaging sensor (e.g., imaging sensor(s) 108A) to light from an exterior environment (e.g., by opening an aperture or the like as described herein) to capture imaging data using the imaging sensor. In some such examples, the imaging system 108 may limit, restrict, or control the readout from the imaging sensor to produce a smaller image frame and/or to focus on a particular subject within the larger image frame. For example, as illustrated in FIG. 2B, by exposing and reading an entire image sensor (e.g., imaging sensor(s) 108A housed in bioptic scanner 210), the imaging system 108 may capture imaging data associated with the imaging field-of-view 202. Additionally, or alternatively, by limiting the readout of the image sensor to a particular sub-section (represented by the controlled readout field-of-view 216) of the imaging field-of-view 202, the imaging system 108 may capture imaging data associated with the controlled readout field-of-view 216. In some examples, the imaging system 108 may isolate any sub-section (e.g., similar to the controlled readout field-of-view 216) of the imaging field-of-view 202. For example, a controlled readout field-of-view may focus on the face of the person 212 and/or an object held at chest level of the person 212. In some examples, a controlled readout field-of-view (e.g., the controlled readout field-of-view 216, a readout limit, a readout setting, and/or the like as described herein) may comprise (or define) a resolution (e.g., equal to or less than a total resolution) of an imaging sensor to produce a partial frame readout and/or a full frame readout. For example, the imaging system 108 may limit the readout of an imaging sensor (e.g., using a readout limit, readout setting, software, hardware, etc.) from 3840 pixels×2160 pixels (or any other resolution) to 1920 pixels×1080 pixels in order to focus on a particular subject (e.g., object, person, etc.).

As shown in FIG. 2B, the imaging system 108 may detect and/or track objects (e.g., product 214) that by-pass (or attempt to by-pass) the indicia scan region 208 (e.g., scan skipping). For example, as shown, the person 212 may attempt to move (intentionally or accidentally) the product 214 from a cart (or the like) to a bagging area without scanning the product indicia (e.g., barcode, etc.) of the product 214 with the product scanner 102. In some such examples, the imaging system 108 may detect (e.g., using one or more object detection algorithms, machine learning models, and/or the like as described herein) the product 214 in the far-stage focus range 206 of the imaging field-of-view 202 and, in response, the imaging system 108 may capture imaging data focusing on the product 214 using the controlled readout field-of-view 216. In some examples, the imaging system 108 may trigger one or more corrective action(s) as described below in connection with FIG. 5. In some examples, the imaging system 108 may identify the product 214 and transmit the product data (e.g., name, description, PLU, etc.) and/or the image of the product to the point-of-sale device(s) 116. In some such examples, the point-of-sale device(s) 116 may (i) add the identified product to the sales transaction (e.g., ring up the product, etc.), (ii) display the image of the product on a display device (e.g., touch screen, etc.), (iii) render a notification asking the customer if they want to purchase the identified product, and/or (iv) perform any other corrective actions as described herein.

In some examples, such as described above and depicted in FIGS. 2A and 2B, the imaging system 108 may adjust (or switch) the focus from the near-stage focus range 204 to the far-stage focus range 206 (and/or vice versa) using one or more focus control techniques and/or settings (e.g., imaging system settings, a gain setting, an illumination setting, etc.) as described herein (e.g., to capture clear, or in-focus, images at various distances along the central axis 202A). In some examples, the imaging system 108 may adjust (or switch) the focus between any two or more focus ranges described herein (e.g., as described below in connection with at least FIGS. 3 and 4). In some examples, the scanner system 200 (or the like as described herein) may control one or more adjustable lenses of a camera (e.g., of imaging system 108) to adjust the focus (e.g., between two or more focus ranges). Example adjustable lenses may comprise, without limitation, one or more of a liquid lens, a 2-step (or any other number) magnet driven lens, a stepper motor driven lens, a solenoid driven lens, a pneumatic lens, a standard zoom lens, a telephoto zoom lens, a varifocal lens, and/or any other adjustable lens as described herein. It should be understood, that one or more scanner systems (as described herein) may adjust (or switch) the focus of one or more imaging sensors (or the like) between a plurality of focus ranges using one or more focus control techniques, settings (e.g., imaging system settings, a gain setting, an illumination setting, etc.), combinations thereof, and/or the like as described herein (e.g., to capture clear, or in-focus, images at various distances and/or locations across one or more fields-of-view.)

In some examples, the scanner system 200 (or the like as described herein) may control an illumination setting for one or more illumination sources (e.g., light source(s) 108B of imaging system 108) to adjust the focus (e.g., between two or more focus ranges). For example, to switch from the far-stage focus range 206 to the near-stage focus range 204, the scanner system 200 may decrease (or reduce) a light source illuminating the person 212 and increase (or amplify) a light source illuminating the indicia scan region 208. It should be appreciated that increasing (or amplifying) a light source may decrease shadows within an illuminated field-of-view making images clearer. It should also be understood that the scanner system 200 may adjust (increase and/or decrease) a light source to optimize contrast and/or shading of a subject in a particular focus range (e.g., decrease illumination to prevent overexposure). In some examples, the scanner system 200 may activate and/or deactivate different light sources (or illumination systems over a portion of an imaging field-of-view.

In some examples, controlling an illumination setting may comprise opening an aperture of an autofocus camera (e.g., of imaging system 108) to collect more light. In some such examples, controlling the illumination setting may comprise reducing an exposure time to reduce (or remove) motion blur. It should be understood that a fixed focus camera may utilize a smaller aperture size (e.g., than an autofocus camera) which may require more light and/or longer exposure times. It should be appreciated that subjects (e.g., objects, etc.) that are farther away from a camera (or the like) may require more illumination and/or different illumination systems (e.g., one or more illumination sources, such as light source(s) 108B and/or the like) to capture a clearer image of the subject.

In some examples, the scanner system 200 (or the like as described herein) may control an exposure time (or exposure length) setting of an imaging sensor to adjust the focus (e.g., between two or more focus ranges). For example, the imaging system 108 may control an exposure time (or exposure length) of an imaging sensor by increasing or decreasing a shutter speed of the associated camera. A faster shutter speed (e.g., equal to or greater than 1/250 seconds, or any other number) to may decrease the exposure time and a slow shutter speed (e.g., less than 1/250 seconds, or any other number) may increase the exposure time. It should be appreciated that the exposure time (or shutter speed, etc.) may not directly impact the focus range, however, changing the exposure time may facilitate changes to an aperture setting and/or an ISO setting which may change the depth of field. For instance, a longer exposure time might require using a smaller aperture (e.g., with a higher f-number) to prevent overexposure which may cause an increase the depth of field which may bring more of the scene into focus (e.g., the subject and more of the background and/or foreground). It should be understood that an f-number (or focal ratio) may be the ratio of the focal length of a camera to the diameter of the aperture of the camera and, in some examples, may be indicative of the amount of light that can enter the lens. It should be appreciated that subjects (e.g., objects, etc.) that are farther away from a camera (or the like) may require longer exposure time and/or increased exposure duration to capture a clearer image of the subject.

In some examples, the scanner system 200 (or the like as described herein) may control a gain setting to adjust the focus (e.g., between two or more focus ranges). It should be understood that gain may refer to the amplification of the signal captured by an imaging sensor (e.g., imaging sensor(s) 108A). In some examples, increasing the gain setting for an imaging sensor may increase the graininess (e.g., noise level, etc.) of an image and produce a less clear (or less sharp) image. In some examples, increasing the gain setting for an imaging sensor may increase brightness and/or decrease contrast (and/or shading) for objects in the image frame. It should be understood that adjusting a gain setting of an image sensor may be combined with other techniques described herein for adjusting focus to increase or decrease image clarity at various ranges from the image sensor. It should be appreciated that subjects (e.g., products, etc.) that are farther away from a camera (or the like) may require higher (or increased) gain to capture a clearer image.

In some examples, the scanner system 200 (or the like as described herein) may control a zoom setting to adjust the focus (e.g., between two or more focus ranges). In some examples, a zoom setting may allow a camera (or image sensor) to make a subject (e.g., product, person, etc.) appear closer or further away in an image. In some examples, the imaging system 108 may control optical zoom by controlling a camera lens to increase or decrease magnification of an image. In some examples, the imaging system 108 may control digital zoom using software to crop and/or magnify a portion of an image. In some examples, the imaging system 108 may use a combination of optical zoom and digital zoom. It should be understood that increasing the zoom of a camera (or the like) may provide a better resolution image for farther away objects (or the like). Additionally, or alternatively, decreasing the zoom of a camera (or the like) may provide a better resolution image for nearer objects (or the like).

In some examples, the scanner system 200 (or the like as described herein) may control a field-of-view angle setting to adjust the focus (e.g., between two or more focus ranges). For example, the scanner system 200 (or the like as described herein) may increase (or widen) a field-of-view angle to focus on closer (or nearer) subjects (e.g., in the near-stage focus range 204). In some such examples, the scanner system 200 (or the like as described herein) may decrease (or narrow) a field-of-view angle to focus on more distant (or farther away) subjects (e.g., in the far-stage focus range 206). In some examples, the imaging system 108 may adjust a field-of-view angle setting and/or a zoom setting to increase the field-of-view resolution for more distant (or farther away) objects. In some examples, the scanner system 200 (or the like) may change the angle of a camera (e.g., a field-of-view angle) to follow a moving object. For example, as an object moves from one side of a field-of-view to another side, the imaging system 108 may increase the field-of-view angle to extend the side-to-side length of the field-of-view to capture the moving object across a wider distance and/or for a longer time.

In some examples, the scanner system 200 (or the like as described herein) may control a resolution setting to adjust the focus (e.g., between two or more focus ranges). For example, an imaging sensor (e.g., imaging sensor(s) 108A) may comprise a plurality of light sensing elements (e.g., pixels in a grid layout or pattern) and the number of light sensing elements (e.g., pixels, etc.) may define the resolution of image produced by the imaging sensor. It should be understood that Image resolution may refer to the amount of detail an image holds and may be measured in pixels (e.g., 1024 pixels×768 pixels, or any other resolution). In some examples, the imaging system 108 may control the resolution of an imaging sensor using one or more binning techniques. For example, the imaging system 108 may combine signals from adjacent pixels into a single signal to produce one larger pixel. In some such examples, the larger pixel may be more sensitivity to changes in light and reduce noise. However, larger pixels may result in a decrease of the overall resolution of the image because there is a decrease in the number of pixel signals. For example, 2×2 binning reduces the resolution of an imaging sensor by a factor of four, as four pixel signals are combined into one pixel signal. In some examples, the imaging system 108 may utilize one or more resolution settings (e.g., defined for the indicia scan region or another area) to generate high resolution images when a product indica (e.g., barcode, etc.) is being scanned in an indicia scan region. In some examples, the imaging system 108 may utilize one or more resolution settings (e.g., defined for the indicia scan region or another area) to generate low resolution images (e.g., reduce the resolution) to increase (or maximize/optimize) throughput at other times. For example, capturing lower resolution images may allow the scanner system 200 to scan one or more product indicia (and/or complete other sales transaction operations described herein) at a faster rate. Still other settings as described herein may be utilized alone or with any other setting(s) to generate high resolution images and/or low resolution images as described above.

In some examples, the scanner system 200 (or the like as described herein) may adjust one or more of a camera (e.g., position, etc.), an imaging sensor (e.g., imaging sensor(s) 108A), and/or any settings as described herein in a circumstance dependent manner. For example, if theft (e.g., scan avoidance, scan skipping, leaving items in a cart, etc.) is suspected then the scanner system 200 (or the like) may shift a focus (or focus range) to obtain a clearer image of a user and/or object (e.g., for later review by employees, law enforcement, etc.). Additionally, or alternatively, the scanner system 200 (or the like as described herein) may adjust one or more of a camera (e.g., position, etc.), an imaging sensor (e.g., imaging sensor(s) 108A), and/or any settings based on one or more other circumstances such as beginning of payment portion of the transaction, when the scanner enters a low power mode, when a face is detected, and/or the like as described herein.

In some examples, the scanner system 200 (or the like as described herein) may switch between two different cameras (or imaging sensors) to adjust the focus (e.g., between two or more focus ranges). For example, a first camera may be configured (e.g., with a wide field-of-view angle, a fixed focus lens, etc.) to monitor a first focus range (e.g., the near-stage focus range 204) and a second camera may be configured (e.g., with a narrow field-of-view angle, a fixed focus lens, etc.) to monitor a second focus range (e.g., the far-stage focus range 206). In some such examples, a plurality of additional cameras may be configured to monitor a plurality of focus ranges. In such examples, the camera (or imaging sensor) may be configured for a particular focus range and the imaging system 108 may switch between cameras to switch between focus ranges. In some examples, such as shown in FIG. 2B, the scanner system 200 (or the like as described herein) may switch between a full frame readout (e.g., imaging field-of-view 202) and one or more partial frame readouts (e.g., controlled readout field-of-view 216) to adjust the focus (e.g., between two or more focus ranges). In some examples, the scanner system 200 (or the like as described herein) may steer one or more cameras (or imaging sensors) to adjust the focus (e.g., between two or more focus ranges). For example, the imaging system 108 may comprise a camera mounted to a gimbal (e.g., gimbal(s) 108C). In such examples, the imaging system 108 may steer the camera (e.g., using the gimbal, motor, etc.) to follow (or track) a location of a subject (e.g., person, object, etc.).

FIG. 3 illustrates a top-down view of an example scanner system with overlapping imaging fields-of-view, according to example embodiments of the present disclosure. As depicted in FIG. 3, the scanner system 300 may comprise, at least in part, the scanner system 100, the scanner system 200, and/or the like as described herein. The scanner system 300, as shown, comprises the product scanner 102, a first imaging field-of-view 302A, and a second imaging field-of-view 312A. As shown in the depicted example, the scanner system 300 may be a self-checkout station (or the like) configured for a customer (e.g., person 212) to scan one or more products (e.g., product 214) and/or identify each product (e.g., using a barcode, imaging data, etc.) to one or more point-of-sale devices (e.g., point-of-sale device(s) 116) that can facilitate the purchase of the product(s). In some such examples, the scanner system 300 may comprise the point-of-sale device(s) 116, as described above for FIG. 1, to facilitate sales and/or financial transactions.

The product scanner 102, as shown, may comprise a bioptic scanner 310. In some examples, the bioptic scanner 310 may comprise, at least in part, the bioptic scanner 210 as described above in connection with FIGS. 2A and 2B. In some examples, the bioptic scanner 310 may comprise a housing that extends above the counter of the self-checkout station and the housing may be configured to enclose, at least in part, two or more cameras (and/or imaging sensors). For example, the bioptic scanner 310 may comprise (or house) a first camera 302 of the imaging system 108 configured (or positioned) to produce a first imaging field-of-view 302A as illustrated. In addition, the bioptic scanner 310 may comprise (or house) a second camera 312 of the imaging system 108 configured (or positioned) to produce a second imaging field-of-view 312A as illustrated. In some examples, the bioptic scanner 310 may comprise (or house) an optical sensor (e.g., optical sensor(s) 104A) of the indicia scanner 104 configured (or positioned) to decode product indicia (e.g., barcodes, etc.) as the products (e.g., product 322, product 324, product 326, product 328, or the like) pass over the indicia scan region 208.

As shown, the first camera 302 may comprise an imaging sensor (e.g., imaging sensor(s) 108A). The first camera 302, as shown, may comprise (or define) a first imaging field-of-view 302A. In the depicted example, the first imaging field-of-view 302A may comprise (or define) a central axis 302B. In some examples, the central axis 302B may comprise, at least in part, one or more aspects (or features) similar to the central axis 202A as described above in connection with FIGS. 2A and 2B. For example, the central axis 302B may represent an imaginary line that runs (e.g., perpendicularly, axially, etc.) through the center of the imaging sensor (e.g., imaging sensor(s) 108A) and/or a camera lens of the first camera 302. In some examples, such as shown, the central axis 302B may extend outward in the direction of the first imaging field-of-view 302A.

In the depicted example, the first imaging field-of-view 302A comprises (or defines) a first near-stage focus range 304 between a lower limit 304A and an upper limit 304B. In some examples, the first near-stage focus range 304 may comprise, at least in part, one or more aspects (or features) similar to the near-stage focus range 204 as described above in connection with FIGS. 2A and 2B. For example, the first near-stage focus range 304 may include any or all portions of the first imaging field-of-view 302A between and/or including the lower limit 304A and the upper limit 304B. As shown, the lower limit 304A and the upper limit 304B may be disposed at respective distances along the central axis 302B so that the first near-stage focus range 304 may cover, at least in part, the indicia scan region 208.

In the depicted example, the first imaging field-of-view 302A comprises (or defines) a first far-stage focus range 306 between a lower limit 306A and an upper limit 306B. In some examples, the first far-stage focus range 306 may comprise, at least in part, one or more aspects (or features) similar to the far-stage focus range 206 as described above in connection with FIGS. 2A and 2B. For example, the first far-stage focus range 306 may include any or all portions of the first imaging field-of-view 302A between and/or including the lower limit 306A and the upper limit 306B. As shown, the lower limit 306A and the upper limit 306B may be disposed at respective distances along the central axis 302B so that the first far-stage focus range 306 may cover, at least in part, one or more of a cart 330, a person 212, and/or any other portions of the external environment adjacent (or around) the scanner system 300.

In some examples, the first near-stage focus range 304 may overlap, at least in part, with the first far-stage focus range 306. In some such examples, the overlap region between the first near-stage focus range 304 and the first far-stage focus range 306 may include any or all portions of the first imaging field-of-view 302A between and/or including the lower limit 306A (of the first far-stage focus range 306) and the upper limit 304B (of the first near-stage focus range 304). It should be appreciated that overlapping focus ranges may be advantageous (or beneficial) so that subjects (e.g., items, people, etc.) may not be missed (or lost) by an imaging system when moving (or traveling) between two or more focus ranges (and/or two or more fields-of-view). For example, the imaging system 108 may switch from the first far-stage focus range 306 to the first near-stage focus range 304 (and/or vice versa) while a subject is in the overlap region in order to (e.g., continuously) maintain an in-focus image of the subject. Additionally, or alternatively, a subject may be more seamlessly tracked by two or more cameras (e.g., first camera 302, second camera 312, and/or the like) if the subject can remain in-focus throughout each camera's respective field-of-view.

As shown, the first camera 302 (and/or a first imaging sensor) may switch between the first near-stage focus range 304 and the first far-stage focus range 306 using one or more focus control techniques, operations, and/or settings (e.g., imaging system settings, a gain setting, an illumination setting, etc.) as described herein (e.g., to capture clear, or in-focus, images at various distances along the central axis 302B). For example, the imaging system 108 (or the like) may cause the first camera 302 (and/or a first imaging sensor) to switch between the first near-stage focus range 304 and the first far-stage focus range 306 by adjusting one or more of a multi-step focus lens (e.g., liquid lens, etc.), a light source (e.g., illumination brightness, etc.), an exposure length, a gain, a zoom, a field-of-view angle, a resolution, and/or any other imaging system settings as described herein to adjust one or more focus ranges. In some examples, the scanner system 300 (or the like) may steer the first camera 302 (and/or a first imaging sensor) using a gimbal (e.g., gimbal(s) 108C, a motor, etc.). In some examples, the scanner system 300 (or the like) may switch between the first camera 302 (and/or a first imaging sensor) and the second camera 312 (e.g., to track or monitor a product as it moves from the cart 330 to the bag 332).

As shown, the second camera 312 may comprise an imaging sensor (e.g., imaging sensor(s) 108A). The second camera 312, as shown, may comprise (or define) a second imaging field-of-view 312A. In the depicted example, the second imaging field-of-view 312A may comprise (or define) a central axis 312B. In some examples, the central axis 312B may comprise, at least in part, one or more aspects (or features) similar to the central axis 202A as described above in connection with FIGS. 2A and 2B. In some examples, the central axis 312B may comprise, at least in part, one or more aspects (or features) similar to the central axis 302B as described herein. For example, the central axis 312B may represent an imaginary line that runs (e.g., perpendicularly, axially, etc.) through the center of the imaging sensor (e.g., imaging sensor(s) 108A) and/or a camera lens of the second camera 312. In some examples, such as shown, the central axis 312B may extend outward in the direction of the second imaging field-of-view 312A.

In the depicted example, the second imaging field-of-view 312A comprises (or defines) a second near-stage focus range 314 between a lower limit 314A and an upper limit 314B. In some examples, the second near-stage focus range 314 may comprise, at least in part, one or more aspects (or features) similar to the near-stage focus range 204 as described above in connection with FIGS. 2A and 2B. In some examples, the second near-stage focus range 314 may comprise, at least in part, one or more aspects (or features) similar to the first near-stage focus range 304 as described herein. For example, the lower limit 314A and the upper limit 314B may be disposed at respective distances along the central axis 312B so that the second near-stage focus range 314 may cover, at least in part, the indicia scan region 208. In some examples, the second near-stage focus range 314 may include any or all portions of the second imaging field-of-view 312A between and/or including the lower limit 314A and the upper limit 314B.

In the depicted example, the second imaging field-of-view 312A comprises (or defines) a second far-stage focus range 316 between a lower limit 316A and an upper limit 316B. In some examples, the second far-stage focus range 316 may comprise, at least in part, one or more aspects (or features) similar to the far-stage focus range 206 as described above in connection with FIGS. 2A and 2B. In some examples, the second far-stage focus range 316 may comprise, at least in part, one or more aspects (or features) similar to the first far-stage focus range 306 as described herein. For example, the second far-stage focus range 316 may include any or all portions of the second imaging field-of-view 312A between and/or including the lower limit 316A and the upper limit 316B. As shown, the lower limit 316A and the upper limit 316B may be disposed at respective distances along the central axis 312B so that the second far-stage focus range 316 may cover, at least in part, one or more of a bag (e.g., bag 332), a bagging area, the person 212, and/or any other portions of the external environment adjacent (or around) the scanner system 300.

In some examples, the second near-stage focus range 314 may overlap, at least in part, with the second far-stage focus range 316. In some such examples, the overlap region between the second near-stage focus range 314 and the second far-stage focus range 316 may include any or all portions of the second imaging field-of-view 312A between and/or including the lower limit 316A (of the second far-stage focus range 316) and the upper limit 314B (of the second near-stage focus range 314). It should be appreciated that overlapping focus ranges may be advantageous (or beneficial) so that subjects (e.g., items, people, etc.) may not be missed (or lost) by an imaging system when moving (or traveling) between two or more focus ranges (and/or two or more fields-of-view). For example, the imaging system 108 may switch from the second far-stage focus range 316 to the second near-stage focus range 314 (and/or vice versa) while a subject is in the overlap region in order to (e.g., continuously) maintain an in-focus image of the subject. Additionally, or alternatively, a subject may be more seamlessly tracked by two or more cameras (e.g., first camera 302, second camera 312, and/or the like) if the subject can remain in-focus throughout each camera's respective field-of-view.

As shown, the second camera 312 (and/or a second imaging sensor) may switch between the second near-stage focus range 314 and the second far-stage focus range 316 using one or more focus control techniques, operations, and/or settings (e.g., imaging system settings, a gain setting, an illumination setting, etc.) as described herein (e.g., to capture clear, or in-focus, images at various distances along the central axis 312B). For example, the imaging system 108 (or the like) may cause the second camera 312 (and/or a second imaging sensor) to switch between the second near-stage focus range 314 and the second far-stage focus range 316 by adjusting one or more of a multi-step focus lens (e.g., liquid lens, etc.), a light source (e.g., illumination brightness, etc.), an exposure length, a gain, a zoom, a field-of-view angle, a resolution, and/or any other imaging system settings as described herein to adjust one or more focus ranges. In some examples, the scanner system 300 (or the like) may steer the second camera 312 (and/or a second imaging sensor) using a gimbal (e.g., gimbal(s) 108C, a motor, etc.). In some examples, the scanner system 300 (or the like) may switch between the second camera 312 (and/or a second imaging sensor) and the first camera 302 (e.g., to detect a unscanned product moving from the cart 330 to the indicia scan region 208).

As shown in FIG. 3, the first imaging field-of-view 302A and the second imaging field-of-view 312A may comprise an overlap region 318. In the overlap region 318 the first imaging field-of-view 302A may overlap, at least in part, with the second imaging field-of-view 312A. In the depicted example, the scanner system 300 (or the like) may detect (or track) one or more subjects (e.g., a person, a product, an object, etc.) at a position within the overlap region 318 (e.g., between two fields-of-view) using a parallax between the first camera 302 (or a first imaging sensor) and the second camera 312 (or a second imaging sensor). In some examples, the imaging system 108 (or the like) may switch from tracking a subject with the first camera 302 (e.g., before it enters, and/or while inside, the overlap region 318) to tracking the subject with the second camera 312 (e.g., while inside, and/or after it exits, the overlap region 318).

In the depicted example of FIG. 3, the imaging system 108 may use the first camera 302 (or a first imaging sensor) to detect and/or track one or more products as they move from the cart 330 (or any other location, at least in part, within the first far-stage focus range 306) to the indicia scan region 208 (or any other location, at least in part, within the first near-stage focus range 304). For example, the first camera 302 (or the like) may detect a product (e.g., at a location as shown by the product 322) in the cart 330 (on a conveyor belt and/or another staging area prior to scanning) and track (or follow) the product (e.g., using object detection algorithms or the like) as a user (e.g., customer, etc.) moves the product toward the indicia scan region 208 (e.g., to a location as shown by the product 324). In some such examples, the imaging system 108 may use the second camera 312 (or a second imaging sensor) to detect and/or track one or more products as they move from the indicia scan region 208 (or any other location, at least in part, within the second near-stage focus range 314) to a bagging area (e.g., the bag 332, a shopping bag carousel, or any other location, at least in part, within the second far-stage focus range 316). For example, the second camera 312 (or the like) may detect the product (e.g., at the location as shown by the product 324) in the indicia scan region 208 and track (or follow) the product (e.g., using object detection algorithms or the like) as a user (e.g., customer, etc.) moves the product toward the bagging area (e.g., to a location as shown by the product 326 within the bag 332). In some examples, when the second camera 312 (or the like) detects (or identifies) the product (e.g., at the location as shown by the product 324) then the first camera 302 (or the like) may switch from the first near-stage focus range 304 to the first far-stage focus range 306 to detect (or identify) another product in the cart 330 (on a conveyor belt and/or another staging area prior to scanning). Additionally, or alternatively, when the second camera 312 (or the like) determines that a product has been bagged (e.g., as shown by the product 326) then the second camera 312 (or the like) may switch from the second far-stage focus range 316 to the second near-stage focus range 314 to detect (or identify) another product in the indicia scan region 208 (e.g., as shown by the product 324). In some examples, the first camera 302 and/or the second camera 312 may cease (or stop) searching for another product to detect, identify, and/or track in response to a customer (e.g., person 212 or the like) initiating a payment process. In some examples, the first camera 302 and/or the second camera 312 may cease (or stop) searching for another product to detect, identify, and/or track if another product cannot be detected (or identified) after a certain amount of time has elapsed. For example, the imaging system 108 may search for one or more products once a customer starts scanning items (or initiates a sales transaction) and may cease searching for products if no products are detected after 30 seconds (or any other time threshold or interval).

In the depicted example of FIG. 3, the imaging system 108 may use the first camera 302 (or a first imaging sensor) and/or the second camera 312 (or a second imaging sensor) to determine whether one or more products by-pass (or attempt to by-pass) the indicia scan region 208 (e.g., scan skipping). For example, as shown, the person 212 may attempt to move (intentionally or accidentally) the product 324 from the cart 330 (from a conveyor belt and/or another staging area prior to scanning) to the bag 332 (or the like) without scanning the product indicia (e.g., barcode, etc.) of the product 328 with the scanner system 300 (e.g., product scanner 102). In some such examples, the imaging system 108 may detect (e.g., using one or more object detection algorithms, machine learning models, and/or the like as described herein) the product 328 in the first far-stage focus range 306 of the first imaging field-of-view 302A (and/or the second far-stage focus range 316 of the second imaging field-of-view 312A) and, in response, the imaging system 108 may capture imaging data focusing on the product 328 (e.g., using the controlled readout field-of-view 216 or the like as described herein). In some examples, the imaging system 108 may trigger one or more corrective action(s) as described below in connection with FIG. 5. In some examples, the imaging system 108 may identify the product 328 (or the like) and transmit the product data (e.g., name, description, PLU, etc.) and/or the image of the product to the point-of-sale device(s) 116. In some such examples, the point-of-sale device(s) 116 may (i) add the identified product to the sales transaction (e.g., ring up the product, etc.), (ii) display the image of the product on a display device (e.g., touch screen, etc.), (iii) render a notification asking the customer if they want to purchase the identified product, and/or (iv) perform any other corrective actions as described herein.

In some examples, the bioptic scanner 310 may comprise one or more wakeup sensors (e.g., one or more detection sensor(s) 106 or the like described herein) to control a 2-step focus adjustment to one or more cameras (e.g., a color camera, a black and white camera, first camera 302, second camera 312, and/or any other imaging sensors and/or cameras described herein). In some such examples, when the one or more wake-up sensors cannot detect an product (e.g., product 324 or the like) in the indicia scan region (e.g., a platter, an in-counter product scanner, and/or the like) the focus of the one or more cameras may be set for extended range (e.g., set to the first far-stage focus range 306, the second far-stage focus range 316, and/or the like). In some examples, if the one or more wakeup sensors detect a product nearby then the focus may be changed (or set) for close up images (e.g., set to the first near-stage focus range 304, the second near-stage focus range 314, and/or the like). It should be appreciated that, in such examples, these techniques (described above) may help keep objects (e.g., products, users, etc.) in focus when farther away (e.g., on a conveyer belt, coming out of a basket or cart, going into a bag, etc.) while still allowing near field objects (e.g., in the indicia scan region 208 or the like) to be in focus. It should be appreciated that these techniques (described above) may apply to variable focus vision cameras (e.g., located below a user (as shown in FIGS. 2A, 2B, and/or 3), located above a display device (as shown in FIG. 4), and/or located at other positions around a user as described herein) to capture in focus images of a face, a hand or body gesture, and/or items passed beyond the indicia scan region and/or a platter end (e.g., scan avoidance, scan skipping, etc.) of the scanner system 300 (or the like).

It should be appreciated that these techniques (described above) may be beneficial (or advantageous) for overhead vision cameras (e.g., as described below in connection with FIG. 4). In some such examples, a multi-step focus is beneficial (or advantageous) because the distances from the camera may vary between a user's face, an indicia scan region, a bottom of a cart, a bottom of a bag, a bottom of a basket, and/or the like as described herein. In some such examples, one or more downward looking (or positioned) cameras (and/or imaging sensors) may use an LED aimer range finder (and/or any other detection sensor(s) 106) configured for range detection (e.g., with long range engines and/or vision systems as described herein). In some such examples, the imaging system 108 may comprise an aimer system comprising one or more LED aimer range finders (and/or any other detection sensor(s) 106). In some such examples, the aimer system may be configured to have elements (e.g., detection elements, sensors, etc.) in several focus ranges (or zones) of a field-of-view in order to detect different objects (e.g., products, packages, produce (fruits, vegetables, etc.), people, etc.) as they are moved around.

FIG. 4 illustrates a perspective view of an example scanner system with overlapping imaging fields-of-view, according to example embodiments of the present disclosure. As depicted in FIG. 4, the scanner system 400 may comprise, at least in part, the scanner system 100, the scanner system 200, the scanner system 300, and/or the like as described herein. The scanner system 400, as shown, comprises the product scanner 102, a first imaging field-of-view 402A, and a second imaging field-of-view 412A. As shown in the depicted example, the scanner system 400 may be a self-checkout station (or the like) configured for a customer (e.g., person 212) to scan one or more products (e.g., product 420, product 422, etc.) and/or identify each product (e.g., using a barcode, imaging data, etc.) to one or more point-of-sale devices (e.g., point-of-sale device(s) 116) that can facilitate the purchase of the product(s). In some such examples, the scanner system 400 may comprise the point-of-sale device(s) 116, as described above for FIG. 1, to facilitate sales and/or financial transactions. In some examples, such as shown, the point-of-sale device(s) 116 may comprise a display device 116A (e.g., touchscreen monitor, screen, etc.). The product scanner 102, as shown, may comprise one or more cameras (or imaging sensors) mounted (or disposed) along a surface of the display device 116A. In some examples, the one or more cameras (or imaging sensors) and/or the display device 116A may comprise one or more detection sensors (e.g., detection sensor(s) 106 or the like as described herein).

As shown, the first camera 402 may comprise an imaging sensor (e.g., imaging sensor(s) 108A) and/or a detection sensor (e.g., detection sensor(s) 106, an LED aimer range finder, an aimer system, and/or the like as described herein). The first camera 402, as shown, may comprise (or define) a first imaging field-of-view 402A. In some examples, the first imaging field-of-view 402A may comprise (or define) a central axis (not shown) as described above in connection with FIGS. 2A, 2B, and 3. In some examples, the central axis of the first imaging field-of-view 402A may comprise, at least in part, one or more aspects (or features) similar to the central axis 202A (as described above in connection with FIGS. 2A and 2B) and/or the central axis 302B (as described above in connection with FIG. 3).

In the depicted example, the first imaging field-of-view 402A comprises (or defines) a first near-stage focus range 404 between a lower limit 404A and an upper limit 404B. In some examples, the first near-stage focus range 404 may comprise, at least in part, one or more aspects (or features) similar to the near-stage focus range 204 (as described above in connection with FIGS. 2A and 2B) and/or the first near-stage focus range 304 (as described above in connection with FIG. 3). For example, the first near-stage focus range 404 may include any or all portions of the first imaging field-of-view 402A between and/or including the lower limit 404A and the upper limit 404B. As shown, the lower limit 404A and the upper limit 404B may be disposed at respective distances away from the first camera 402 to cover, at least in part, the indicia scan region 208.

In the depicted example, the first imaging field-of-view 402A comprises (or defines) a first far-stage focus range 406 between a lower limit 406A and an upper limit 406B. In some examples, the first far-stage focus range 406 may comprise, at least in part, one or more aspects (or features) similar to the far-stage focus range 206 (as described above in connection with FIGS. 2A and 2B) and/or the first far-stage focus range 306 (as described above in connection with FIG. 3). For example, the first far-stage focus range 406 may include any or all portions of the first imaging field-of-view 402A between and/or including the lower limit 406A and the upper limit 406B. As shown, the lower limit 406A and the upper limit 406B may be disposed at respective distances away from the first camera 402 to cover, at least in part, a bottom of a cart (e.g., cart 430), a bottom of a bag, a bottom of a basket, and/or the like as described herein.

In some examples, the first near-stage focus range 404 may overlap, at least in part, with the first far-stage focus range 406. In some such examples, the overlap region between the first near-stage focus range 404 and the first far-stage focus range 406 may include any or all portions of the first imaging field-of-view 402A between and/or including the lower limit 406A (of the first far-stage focus range 406) and the upper limit 404B (of the first near-stage focus range 404). It should be appreciated that overlapping focus ranges may be advantageous (or beneficial) so that subjects (e.g., items, people, etc.) may not be missed (or lost) by an imaging system when moving (or traveling) between two or more focus ranges (and/or two or more fields-of-view). For example, the imaging system 108 may switch from the first far-stage focus range 406 to the first near-stage focus range 404 (and/or vice versa) while a subject is in the overlap region in order to (e.g., continuously) maintain an in-focus image of the subject. Additionally, or alternatively, a subject may be more seamlessly tracked by two or more cameras (e.g., first camera 402, second camera 412, and/or the like) if the subject can remain in-focus throughout each camera's respective field-of-view.

As shown, the first camera 402 (and/or a first imaging sensor) may switch between the first near-stage focus range 404 and the first far-stage focus range 406 using one or more focus control techniques, operations, and/or settings (e.g., imaging system settings, a gain setting, an illumination setting, etc.) as described herein (e.g., to capture clear, or in-focus, images at various distances from the first camera 402). For example, the imaging system 108 (or the like) may cause the first camera 402 (and/or a first imaging sensor) to switch between the first near-stage focus range 404 and the first far-stage focus range 406 by adjusting one or more of a multi-step focus lens (e.g., liquid lens, etc.), a light source (e.g., illumination brightness, etc.), an exposure length, a gain, a zoom, a field-of-view angle, a resolution, and/or any other imaging system settings as described herein to adjust one or more focus ranges. In some examples, the scanner system 400 (or the like) may steer the first camera 402 (and/or a first imaging sensor) using a gimbal (e.g., gimbal(s) 108C, a motor, etc.), for example, the first camera 402 may swivel (or change position) to capture a face, a body or hand gesture, and/or to position a cart, basket, and/or the like in an image frame. In some examples, the scanner system 400 (or the like) may switch between the first camera 402 (and/or a first imaging sensor) and the second camera 412 (e.g., to track or monitor a product as it moves from the position of product 420 to the position of product 422).

As shown, the second camera 412 may comprise an imaging sensor (e.g., imaging sensor(s) 108A) and/or a detection sensor (e.g., detection sensor(s) 106, an LED aimer range finder, an aimer system, and/or the like as described herein). The second camera 412, as shown, may comprise (or define) a second imaging field-of-view 412A. In some examples, the second imaging field-of-view 412A may comprise (or define) a central axis (not shown) as described above in connection with FIGS. 2A, 2B, and 3. In some examples, the central axis of the second imaging field-of-view 412A may comprise, at least in part, one or more aspects (or features) similar to the central axis 202A (as described above in connection with FIGS. 2A and 2B) and/or the central axis 312B (as described above in connection with FIG. 3).

In the depicted example, the second imaging field-of-view 412A comprises (or defines) a second near-stage focus range 414 between a lower limit 414A and an upper limit 414B. In some examples, the second near-stage focus range 414 may comprise, at least in part, one or more aspects (or features) similar to the near-stage focus range 204 (as described above in connection with FIGS. 2A and 2B) and/or the second near-stage focus range 314 (as described above in connection with FIG. 3). For example, the second near-stage focus range 414 may include any or all portions of the second imaging field-of-view 412A between and/or including the lower limit 414A and the upper limit 414B. As shown, the lower limit 414A and the upper limit 414B may be disposed at respective distances away from the second camera 412 to cover, at least in part, the indicia scan region 208.

In the depicted example, the second imaging field-of-view 412A comprises (or defines) a second far-stage focus range 416 between a lower limit 416A and an upper limit 416B. In some examples, the second far-stage focus range 416 may comprise, at least in part, one or more aspects (or features) similar to the far-stage focus range 206 (as described above in connection with FIGS. 2A and 2B) and/or the second far-stage focus range 316 (as described above in connection with FIG. 3). For example, the second far-stage focus range 416 may include any or all portions of the second imaging field-of-view 412A between and/or including the lower limit 416A and the upper limit 416B. As shown, the lower limit 416A and the upper limit 416B may be disposed at respective distances away from the second camera 412 to cover, at least in part, a bottom of a cart (e.g., cart 430), a bottom of a bag, a bottom of a basket, and/or the like as described herein.

In some examples, the second near-stage focus range 414 may overlap, at least in part, with the second far-stage focus range 416. In some such examples, the overlap region between the second near-stage focus range 414 and the second far-stage focus range 416 may include any or all portions of the second imaging field-of-view 412A between and/or including the lower limit 416A (of the second far-stage focus range 416) and the upper limit 414B (of the second near-stage focus range 414). It should be appreciated that overlapping focus ranges may be advantageous (or beneficial) so that subjects (e.g., items, people, etc.) may not be missed (or lost) by an imaging system when moving (or traveling) between two or more focus ranges (and/or two or more fields-of-view). For example, the imaging system 108 may switch from the second far-stage focus range 416 to the second near-stage focus range 414 (and/or vice versa) while a subject is in the overlap region in order to (e.g., continuously) maintain an in-focus image of the subject. Additionally, or alternatively, a subject may be more seamlessly tracked by two or more cameras (e.g., first camera 402, second camera 412, and/or the like) if the subject can remain in-focus throughout each camera's respective field-of-view.

As shown, the second camera 412 (and/or a second imaging sensor) may switch between the second near-stage focus range 414 and the second far-stage focus range 416 using one or more focus control techniques, operations, and/or settings (e.g., imaging system settings, a gain setting, an illumination setting, etc.) as described herein (e.g., to capture clear, or in-focus, images at various distances from the second camera 412). For example, the imaging system 108 (or the like) may cause the second camera 412 (and/or a second imaging sensor) to switch between the second near-stage focus range 414 and the second far-stage focus range 416 by adjusting one or more of a multi-step focus lens (e.g., liquid lens, etc.), a light source (e.g., illumination brightness, etc.), an exposure length, a gain, a zoom, a field-of-view angle, a resolution, and/or any other imaging system settings as described herein to adjust one or more focus ranges. In some examples, the scanner system 400 (or the like) may steer the second camera 412 (and/or a second imaging sensor) using a gimbal (e.g., gimbal(s) 108C, a motor, etc.), for example, the second camera 412 may swivel (or change position) to capture a face, a body or hand gesture, and/or to position a bag, basket, and/or the like in an image frame.

As shown in FIG. 4, the first imaging field-of-view 402A and the second imaging field-of-view 412A may comprise an overlap region 418. In the overlap region 418 the first imaging field-of-view 402A may overlap, at least in part, with the second imaging field-of-view 412A. In the depicted example, the scanner system 400 (or the like) may detect (or track) one or more subjects (e.g., a person, a product, an object, etc.) at a position within the overlap region 418 (e.g., between two fields-of-view) using a parallax between the first camera 402 (or a first imaging sensor) and the second camera 412 (or a second imaging sensor). In some examples, the imaging system 108 (or the like) may switch from tracking a subject with the first camera 402 (e.g., before it enters, and/or while inside, the overlap region 418) to tracking the subject with the second camera 412 (e.g., while inside, and/or after it exits, the overlap region 318).

FIG. 5 illustrates an example flowchart for switching between focus ranges of one or more imaging fields-of-view using an example scanner system, according to example embodiments of the present disclosure. As shown, the process 500 may be used for adjusting the focus range of one or more imaging sensors using an example scanner system (e.g., scanner system 100, scanner system 200, scanner system 300, scanner system 400 and/or the like). The operations of the process 500 may represent a series of instructions comprising computer readable machine code executable by a processing unit (e.g., processor(s) 110) of the product scanner 102 (or any other computing device described herein), although various operations may also be implemented in, or using, one or more specifically designed logic circuits (e.g., ASIC, etc.). In some examples, the computer readable machine codes may be comprised of instructions selected from a native instruction set of at least one processor (e.g., processor(s) 110) and/or an operating system of the product scanner 102 (or any other computing device described herein). In some examples, the process 500 may be performed, at least in part, by one or more components of an example scanner system (e.g., scanner system 100, scanner system 200, scanner system 300, scanner system 400, and/or the like). For example, the process 500 may be performed by an apparatus (e.g., scanner system 100, product scanner 102, detection sensor(s) 106, imaging system 108, point-of-sale device(s) 116, etc.) comprising at least one processor (e.g., processor(s) 110) and at least one machine-readable storage device (e.g., memory 112) storing processor executable instructions which, when executed using the at least one processor, causes the apparatus to perform, at least in part, one or more of operations 502-522 (and/or the like) as described herein. In some examples, the process 500 may comprise one or more operations, techniques, and/or features as described above in connection with at least FIGS. 1, 2A, 2B, 3, and/or 4. In some examples, the process 500 may represent a computer-implemented method for adjusting the focus (or focus range) of one or more imaging sensors (and/or cameras) of an imaging system.

As shown in FIG. 5, the process 500 may begin at operation 502, at which an apparatus may detect a person in a first focus range. For example, a customer (e.g., person 212) may walk into (or enter) a far-stage focus range (e.g., between lower limit 206A and upper limit 206B shown in FIGS. 2A and 2B) of the imaging field-of-view 202 as shown in FIG. 2A and described above. In some examples, the operation 502 may comprise determining whether a person is present in imaging data using one or more vision machine learning models and/or algorithms. For example, a camera of the imaging system 108 (and/or the detection sensor(s) 106) may monitor the environment around a point-of-sale device to determine when a customer is present. In some examples, the operation 502 may comprise generating (e.g., using the imaging system 108, processor(s) 110, etc.) an activation signal configured to power-on one or more computing devices (e.g., of a scanner system). In some examples, the operation 502 may comprise transmitting (e.g., using the imaging system 108, processor(s) 110, etc.) the activation signal via a communications interface (e.g., communications interface(s) 114) to one or more computing devices and/or components of a scanner system (e.g., the indicia scanner 104, the point-of-sale device(s) 116, the imaging system 108, etc.). In some examples, the operation 502 may comprise determining that an object is within a first focus range (e.g., a far-stage focus range, etc.). In some examples, the operation 502 may comprise adjusting a focus of an imaging sensor to the first focus range. In some examples, the operation 502 may comprise adjusting a focus of an imaging sensor to the first focus range. In some examples, the operation 502 may comprise detecting an object at a position within an imaging field-of-view using a detection sensor. In some such examples, the operation 502 may comprise generating a detection signal that is representative of at least one of (i) the position within the imaging field-of-view or (ii) a distance between the position and the imaging sensor. In some such examples, the operation 502 may comprise causing transmission of (or transmitting) the detection signal to the imaging system from the detection sensor (e.g., using communications interface(s) 114). In some examples, the operation 502 may comprise detecting an object at a position within the overlap region (e.g., between two fields-of-view) based on a parallax between the imaging sensor and the second imaging sensor.

The process 500 may continue at operation 504, at which the apparatus may power-on, at least in part, a scanner system (e.g., scanner system 100 and/or the like as described herein). For example, the apparatus may power-on (and/or wake-up), at least in part, an indicia scanner 104, an imaging system 108, point-of-sale device(s) 116, and/or the like as described herein. In some examples, the operation 504 may comprise receiving (e.g., by the indicia scanner 104, by the imaging system 108, by the point-of-sale device(s) 116, etc.) the activation signal via a communications interface (e.g., via communications interface(s) 114). In some examples, the indicia scanner 104, the imaging system 108, the point-of-sale device(s) 116, etc., may power-on but may remain in a stand-by (or sleep) mode to conserve energy (e.g., until a user starts scanning products and/or until a product is detected as described below at operation 506).

The process 500 may continue at operation 506, at which the apparatus may detect an object in a second focus range. For example, a customer (e.g., person 212) may remove a product (e.g., as shown by the product 322) from a shopping cart (e.g., cart 330) and move the product (e.g., as shown by the product 324) toward the indicia scan region 208 and into the near-stage (e.g., between upper limit 304B and lower limit 304A) of the first imaging field-of-view 302A as shown in FIG. 3 and described above. In some such examples, the imaging system 108 may detect the product (e.g., as shown by the product 324) in the near-stage (e.g., between upper limit 304B and lower limit 304A) of the first imaging field-of-view 302A using an object detection algorithm. In some examples, the detection sensor(s) 106 may detect the product (e.g., as shown by the product 324) in the near-stage (e.g., between upper limit 304B and lower limit 304A) of the first imaging field-of-view 302A. In some examples, the operation 506 may comprise generating a wake signal configured to wake-up one or more computing devices and/or components of a scanner system (e.g., the indicia scanner 104, the point-of-sale device(s) 116, etc.). In some examples, the operation 506 may comprise transmitting (e.g., using the imaging system 108, processor(s) 110, etc.) the wake signal via a communications interface (e.g., communications interface(s) 114) to one or more computing devices and/or components of a scanner system (e.g., the indicia scanner 104, the point-of-sale device(s) 116, etc.) in order to capture (or decode) product indicia (e.g., barcode, etc.) data. In some examples, the operation 506 may comprise determining that an object (e.g., product, etc.) is within a second focus range. In some examples, the operation 506 may comprise detecting an object at a position within an imaging field-of-view using a detection sensor. In some such examples, the operation 506 may comprise generating a detection signal that is representative of at least one of (i) the position within the imaging field-of-view or (ii) a distance between the position and the imaging sensor. In some such examples, the operation 506 may comprise causing transmission of (or transmitting) the detection signal to the imaging system from the detection sensor (e.g., using communications interface(s) 114). In some examples, the operation 506 may comprise detecting an object at a position within the overlap region (e.g., between two fields-of-view) based on a parallax between the imaging sensor and the second imaging sensor.

The process 500 may continue at operation 508, at which the apparatus may adjust a focus to the second focus range. In some examples, the operation 508 may comprise adjusting the focus of an imaging sensor to the second focus range. For example, the depth of focus of the imaging system 108 may be set to the far-stage focus range (e.g., between lower limit 206A and upper limit 206B shown in FIGS. 2A and 2B) in order to detect a customer (or other person) as described above at the operation 502. In addition, the imaging system 108 may switch from focusing on the far-stage focus range to focusing on the near-stage focus range (e.g., between lower limit 204A and upper limit 204B shown in FIGS. 2A and 2B) to capture imaging data (e.g., video, etc.) of the product (e.g., the product 324 as it enters the indicia scan region 208). In some examples, the operation 508 may comprise adjusting one or more of a multi-step focus lens (e.g., liquid lens, etc.), a light source (e.g., illumination brightness, etc.), an exposure length, a gain, a zoom or field-of-view angle, a resolution, and/or any other imaging system settings as described herein to adjust one or more focus ranges. In some examples, the operation 508 may comprise switching from a first (e.g., far-stage fixed focus) camera to a second (e.g., near-stage fixed focus) camera. In some examples, the operation 508 may comprise steering one or more cameras (and/or imaging sensors) using a gimbal (e.g., the gimbal(s) 108C) to position the one or more cameras (and/or imaging sensors) to focus on a second focus range (e.g., different from the first focus range of the operation 502, a far-stage focus range, a near-stage focus range, etc.).

In some examples, such as illustrated in FIG. 5, the operation 508 may proceed, at least in part, to the operation 514 as described below. In some such examples, the imaging system 108 may capture imaging data (as described below at the operation 514) while the object (e.g., a product, etc.) is within the second focus range before then proceeding to the operation 510 as described below. In some such examples, the operation 514 may proceed to the operation 516 as described below (e.g., omitting the operation 510 and/or the operation 512).

The process 500 may continue at operation 510, at which the apparatus may detect an object in one or more additional focus ranges. For example, a customer (e.g., person 212) may remove a product (e.g., as shown by the product 324) from the indicia scan region 208 and move the product (e.g., as shown by the product 326) into the bagging area which is in the far-stage (e.g., between upper limit 316B and lower limit 304A) of the second imaging field-of-view 312A as shown in FIG. 3 and described above. In some such examples, the imaging system 108 may detect the product (e.g., as shown by the product 324) in the near-stage (e.g., between upper limit 304B and lower limit 304A) of the first imaging field-of-view 302A and/or the near-stage (e.g., between upper limit 314B and lower limit 314A) of the second imaging field-of-view 312A using an object detection algorithm. In addition, the imaging system 108 may detect (and/or track) the product as it transitions to the far-stage (e.g., between upper limit 316B and lower limit 304A) of the second imaging field-of-view 312A. In some examples, the detection sensor(s) 106 may detect the product (e.g., as shown by the product 324) in the near-stage (e.g., between upper limit 304B and lower limit 304A) of the first imaging field-of-view 302A (and/or the near-stage (e.g., between upper limit 314B and lower limit 314A) of the second imaging field-of-view 312A). In addition, the detection sensor(s) 106 may detect (and/or track) the product as it transitions to the far-stage (e.g., between upper limit 316B and lower limit 304A) of the second imaging field-of-view 312A. In some examples, the operation 510 may comprise detecting an object at a position within an imaging field-of-view using a detection sensor. In some such examples, the operation 510 may comprise generating a detection signal that is representative of at least one of (i) the position within the imaging field-of-view or (ii) a distance between the position and the imaging sensor. In some such examples, the operation 510 may comprise causing transmission of (or transmitting) the detection signal to the imaging system from the detection sensor (e.g., using communications interface(s) 114). In some examples, the operation 510 may comprise detecting an object at a position within the overlap region (e.g., between two fields-of-view) based on a parallax between the imaging sensor and the second imaging sensor.

In some examples, the operation 510 may comprise detecting an object in one or more additional focus ranges by-passing the indicia scan region 208 (e.g., detecting scan skipping). For example, a customer (e.g., person 212) may remove a product (e.g., as shown by the product 324) from the indicia scan region 208 and move the product (e.g., as shown by the product 326) into the bagging area which is in the far-stage (e.g., between upper limit 316B and lower limit 304A) of the second imaging field-of-view 312A as shown in FIG. 3 and described above. For example, a customer (e.g., person 212) may remove a product (e.g., as shown by the product 322) from a shopping cart (e.g., cart 330) and move the product (e.g., as shown by the product 328) around the indicia scan region 208 and into the far-stage (e.g., between upper limit 306B and lower limit 306A) of the first imaging field-of-view 302A and/or the far-stage (e.g., between upper limit 316B and lower limit 316A) of the second imaging field-of-view 312A as shown in FIG. 3 and described above. In some such examples, the imaging system 108 and/or the detection sensor(s) 106 may detect the product (e.g., as shown by the product 328) as it by-passes the indicia scan region (e.g., using object detection algorithms, etc.). In some examples, the operation 510 may comprise generating an alert signal that indicates that an object (e.g., product) by-passed the product scanner (e.g., an indicia scanner, an indicia scan region, etc.). In some examples, the alert signal may trigger one or more corrective actions as described herein. In some such examples, the operation 510 may proceed to the operation 522 as described above (e.g., to initiate one or more corrective actions).

The process 500 may continue at operation 512, at which the apparatus may adjust the focus to the one or more additional focus ranges. For example, the depth of focus of the imaging system 108 may be set to the near-stage focus range of the first imaging field-of-view 302A (e.g., between lower limit 304A and upper limit 304B) in order to detect the product (e.g., shown as product 324) entering the indicia scan region 208 as described above at the operation 510. In addition, the imaging system 108 may switch from focusing on the near-stage focus range of the first imaging field-of-view 302A (e.g., between lower limit 304A and upper limit 304B) to focusing on the near-stage of the second imaging field-of-view 312A (e.g., between lower limit 314A and upper limit 314B). In some examples, the operation 512 may comprise adjusting one or more of a multi-step focus lens (e.g., liquid lens, etc.), a light source (e.g., illumination brightness, etc.), an exposure length, a gain, a zoom or field-of-view angle, a resolution, and/or any other imaging system settings as described herein to adjust one or more focus ranges.

In some examples, the operation 512 may comprise switching from a first camera (e.g., the first camera 302) to a second camera (e.g., the second camera 312). In some examples, the operation 512 may comprise steering one or more cameras (and/or imaging sensors) using a gimbal (e.g., the gimbal(s) 108C) to position the one or more cameras (and/or imaging sensors) to focus on the one or more additional focus ranges. In some examples, the operation 512 may comprise activating (and/or focusing) a second camera (e.g., the second camera 312) while simultaneously maintaining the focus of a first camera (e.g., the first camera 302). In some examples, a first camera (e.g., the first camera 302) may switch between a far-stage focus range and a near-stage focus range to track objects as they enter the indicia scan region and a second camera (e.g., the second camera 312) may switch between a near-stage focus range and a far-stage focus range to track objects as they exit the indicia scan region. In some such examples, the first camera (e.g., the first camera 302) may monitor one or more of a conveyor belt, a cart, a basket, the indicia scan region, and/or any other area around the scanner system. In some such examples, the second camera (e.g., the second camera 312) may monitor one or more of a bagging area, a bag, the indicia scan region, and/or any other area around the scanner system.

The process 500 may continue at operation 514, at which the apparatus may capture imaging data. In some examples, the operation 514 may comprise capturing a still image, a picture, and/or the like as described herein using one or more cameras (and/or imaging sensors). For example, when a product pauses (at least temporarily) for the indicia scanner 104 to decode a barcode (or the like), the imaging system 108 may capture imaging data representative of at least one exterior surface of an object (e.g., a product, a package, etc.). In some examples, the operation 514 may comprise recording a video, a series of image frames, and/or the like as described herein using one or more cameras (and/or imaging sensors). For example, when a product moves from a shopping cart (or the like) to a bagging area, the imaging system 108 may capture a video of the product as it moves from a cart to a bag. In some examples, the operation 514 may comprise continuously (or periodically) recording one or more videos of an object (e.g., product, person, etc.) in the exterior environment of the scanner system (e.g., scanner system 100, etc.). In some other examples, the operation 514 may comprise periodically capturing one or more images (e.g., still frame images, pictures, etc.) of an object (e.g., product, person, etc.) in the exterior environment of the scanner system (e.g., scanner system 100, etc.). In some examples, the operation 514 may comprise exposing a full frame of one or more image sensors (e.g., of one or more cameras). In some such examples, the operation 514 may comprise reading out a whole frame of one or more image sensors. In some other examples, the operation 514 may comprise reading out (e.g., using one or more readout controls) at least a part of a whole frame of one or more image sensors. In some such examples, the imaging system 108 may use one or more readout controls to only readout a portion of the whole frame of an image sensor. In some examples, the operation 514 may comprise capturing first imaging data that is representative of an object (e.g., person, product, etc.) in the first focus range (as described at the operation 502) of the imaging field-of-view. In some examples, the operation 514 may comprise capturing second imaging data that is representative of an object (e.g., person, product, etc.) in the second focus range (as described at the operation 506) of the imaging field-of-view.

The process 500 may continue at operation 516, at which the apparatus may capture indicia data. In some examples, the operation 516 may comprise capturing (or decoding) (e.g., using the indicia scanner 104) indicia data from a product indicia (e.g., barcode, QR code, etc.). In some examples, the operation 516 may comprise capturing indicia data from a product indicia disposed within an indicia scan region and, in some such example, the indicia scan region (e.g., indicia scan region 208) may be defined by an optical field-of-view of an optical sensor of the indicia scanner 104. In some examples, the indicia scanner 104 may capture (or decode) indicia data in response to receiving a command signal. For example, the imaging system 108 may detect a product in range of the indicia scanner 104 and, in response, the indicia scanner 104 may be controlled to decode a product indicia (e.g., barcode, etc.) associated with the product (e.g., in a near-stage focus range). In some examples, the operation 516 may comprise capturing (e.g., using the imaging system 108) image data and/or video data of a product. In some examples, the imaging system 108 may capture (or decode) indicia data in response to receiving a command signal (as described above at operation 510). For example, the imaging system 108 may detect a product in the scan indicia scan region (as described herein) and, in response, may capture (or record) an image of the product. Additionally, or alternatively, the imaging system 108 may decode a product indicia that is visible in an image of the product to capture the associated indicia data.

The process 500 may continue at operation 518, at which the apparatus may determine whether the indicia data and the imaging data match (e.g., the same product). In some examples, the operation 518 may comprise storing imaging data representative of an exterior feature of a product and/or packaging to a memory device (e.g., memory 112, etc.). In some examples, the operation 518 may comprise storing indicia data representative of a product and/or packaging to a memory device (e.g., memory 112, etc.). In some examples, the operation 518 may comprise accessing (or retrieving) product image training data from one or more product image databases (e.g., on storage device(s) 120). In some examples, the operation 518 may comprise accessing (or retrieving) indicia data from one or more product indicia databases (e.g., on storage device(s) 120), such as by querying (or searching) a data table comprising PLU codes (and/or the like) using the decoded indicia data. In some examples, the operation 518 may comprise comparing, at least in part, the imaging data and the indicia data. In some such examples, the operation 518 may comprise determining, to within a decision threshold (e.g., equal to, or greater than, 95% certainty or another number), whether the imaging data is representative of the same product that is indicated by the indicia data. In some examples, a vision system machine learning model may identify a known product and/or package based on the imaging data and compare the known product and/or package from the imaging data to a known product and/or package identified by the indicia data. For example, the product information decoded from the product indicia may be compared to the identified known product and/or package to determine whether the product indicia matches the identified product. In some examples, the operation 518 may comprise determining whether a product indicia was decoded and/or scanned. For example, a vision system machine learning model may identify an object (e.g., known product and/or package) based on the imaging data and may determine that a product indicia was not decoded and/or scanned in relation to the object from the imaging data. For example, a vision system machine learning model may identify a product that was moved around the indicia scanner to prevent the decoding (or scanning) of a barcode (and/or the like as described herein).

In an instance that the product and/or the package identified from the imaging data (e.g., still image frames, video data, etc.) matches the product and/or package identified by a product indicia, then the process 500 may proceed to the operation 520 as described below.

In an instance that the product and/or the package identified from the imaging data (e.g., still image frames, video data, etc.) does not match the product and/or package identified by a product indicia, then the process 500 may proceed to the operation 522 as described below. In an instance that an indicia scanner does not scan (or does not decode) a product indicia associated with a product and/or the package identified from the imaging data, then the process 500 may proceed to the operation 522 as described below.

The process 500 may continue at operation 520, at which the apparatus may complete a transaction. In some examples, the operation 520 may comprise calculating a cost to purchase any or all products scanned by the indicia scanner 104. In some examples, the operation 520 may comprise generating a sales transaction comprising the cost to purchase any or all products scanned by the indicia scanner 104. In some examples, the operation 520 may comprise rendering (e.g., on a display device of a point-of-sale device) a summary of the sales transaction (e.g., list of products and prices, etc.) and instructions to complete a payment process (e.g., via a card reader, cash recycler, etc.). In some examples, the operation 520 may comprise processing a payment (e.g., from a customer) to complete the sales transaction to purchase one or more products. In some examples, the operation 520 may comprise rendering (e.g., on a display device of a point-of-sale device) a notification (e.g., to a customer) indicating that the sales transaction was successfully completed.

The process 500 may continue at operation 522, at which the apparatus may initiate corrective action(s). Examples of corrective actions may comprise, without limitation, one or more of rendering a notification to a customer, rendering a notification to an employee, locking a point-of-sale device, activating a security camera, and/or any other corrective actions as described herein. In some examples, the operation 522 may comprise rendering (e.g., on a display device of a point-of-sale device) a notification (e.g., to a customer) indicating that a product was not successfully identified (e.g., based on one or more of image data, video data, indicia data, etc.). For example, the display device of a point-of-sale device may render a notification (e.g., text message, audible message, etc.) indicating that a product (e.g., identified by the imaging system 108) is in the bagging area but was not scanned by an indicia scanner (e.g., indicia scanner 104). Additionally, or alternatively, the display device of a point-of-sale device may render a notification indicating that a product that was scanned by the indicia scanner does not appear to be the correct product (e.g., the barcode does not match the image data and/or the video data). In some examples, the operation 522 may comprise blocking (or pausing) use of a point-of-sale device (e.g., self-checkout station, etc.). In some such examples, the operation 522 may comprise notifying an employee to scan and/or verify the identity of one or more products. In some examples, the operation 522 may comprise capturing image data and/or video data (e.g., using a vision system and/or a security camera) that is representative of the environment around the point-of-sale device (e.g., self-checkout station, etc.) and/or the location of one or more persons in the environment. In some examples, one or more corrective actions may be performed in response to a detection (or determination) of an instance of ticket switching, an instance of scan avoidance, and/or the like as described herein. For example, in response to detecting an instance of ticket switching and/or an instance of scan avoidance, the imaging system 108 may focus on a subject (e.g., product, person, face, etc.) associated with the one or more instances and/or capture an image of the subject. In some examples, the image of the subject may be tagged with metadata (or the like) indicating that the image was captured in response to an instance of ticket switching, an instance of scan avoidance, and/or the like.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more Digital Signal Processors (DSPs), one or more Application Specific Integrated Circuits (ASICs), one or more Field-Programmable Gate Arrays (FPGAs), one or more microcontroller units (MCUs), one or more hardware accelerators, one or more special-purpose computer chips, and one or more System on a Chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may be combined, divided, re-arranged, and/or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s) and/or the like). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” and/or “contains . . . a,” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A product scanner, comprising:
a housing;
an indicia scanner comprising an optical light source, an optical sensor, and a lens wherein the indicia scanner is configured to:
capture indicia data from a product indicia disposed within an indicia scan region, wherein the indicia scan region is defined by an optical field-of-view of the optical sensor; and
an imaging system comprising an imaging sensor comprising an imaging field-of-view, wherein the imaging field-of-view comprises a first focus range and a second focus range, and wherein the imaging system is configured to:
determine that an object is within the first focus range;
adjust a focus of the imaging sensor to the first focus range;
capture first imaging data that is representative of the object in the first focus range of the imaging field-of-view;
determine that the object is within the second focus range;
adjust the focus of the imaging sensor to the second focus range; and
capture second imaging data that is representative of the object in the second focus range of the imaging field-of-view.

2. The product scanner of claim 1, wherein the imaging field-of-view comprises a central axis extending perpendicularly from the imaging sensor, wherein the first focus range comprises a first lower boundary and a first upper boundary, wherein the first lower boundary is disposed along the central axis at a first lower distance from the imaging sensor, and wherein the first upper boundary is disposed along the central axis at a first upper distance from the imaging sensor.

3. The product scanner of claim 2, wherein the second focus range comprises a second lower boundary and a second upper boundary, wherein the second lower boundary is disposed along the central axis at a second lower distance from the imaging sensor, and wherein the second upper boundary is disposed along the central axis at a second upper distance from the imaging sensor.

4. The product scanner of claim 1, comprising:
a detection sensor comprising at least one of a 3D sensor, a range finder, or an infrared sensor, wherein the detection sensor is configured to:
detect the object at a position within the imaging field-of-view;
generate a detection signal that is representative of at least one of (i) the position within the imaging field-of-view or (ii) a distance between the position and the imaging sensor; and
cause transmission of the detection signal to the imaging system.

5. The product scanner of claim 1, wherein the imaging system comprises:
a second imaging sensor comprising a second imaging field-of-view, wherein the second imaging field-of-view comprises a third focus range and a fourth focus range, wherein the imaging system is configured to:
determine that the object is within the third focus range;
adjust a focus of the second imaging sensor to the third focus range;
capture third imaging data that is representative of the object in the third focus range of the second imaging field-of-view;
determine that the object is within the fourth focus range;
adjust the focus of the imaging sensor to the second focus range; and
capture fourth imaging data that is representative of the object in the fourth focus range of the second imaging field-of-view.

6. The product scanner of claim 5, wherein the second imaging field-of-view comprises a second central axis extending perpendicularly from the second imaging sensor, wherein the third focus range comprises a third lower boundary and a third upper boundary, wherein the third lower boundary is disposed along the second central axis at a third lower distance from the imaging sensor, and wherein the third upper boundary is disposed along the second central axis at a third upper distance from the second imaging sensor.

7. The product scanner of claim 6, wherein the fourth focus range comprises a fourth lower boundary and a fourth upper boundary, wherein the fourth lower boundary is disposed along the second central axis at a fourth lower distance from the second imaging sensor, and wherein the fourth upper boundary is disposed along the second central axis at a fourth upper distance from the second imaging sensor.

8. The product scanner of claim 5, wherein the imaging field-of-view of the imaging sensor comprises an overlap region that overlaps, at least in part, with the second imaging field-of-view of the second imaging sensor,
wherein the imaging system is configured to:
detect the object at a position within the overlap region based on a parallax between the imaging sensor and the second imaging sensor.

9. The product scanner of claim 8, wherein the position within the overlap region is further within (i) the second focus range of the imaging sensor and (ii) the third focus range of the second imaging sensor,
wherein the imaging system is configured to:
adjust the focus of the imaging sensor to the second focus range;
adjust the focus of the second imaging sensor to the third focus range;
determine that the object was scanned by the indicia scanner; and
search for another object within at least one of (i) the first focus range of the imaging sensor or (ii) the fourth focus range of the second imaging sensor.

10. The product scanner of claim 8, wherein the position within the overlap region is further within (i) the first focus range of the imaging sensor and (ii) the fourth focus range of the second imaging sensor,
wherein the imaging system is configured to:
adjust the focus of the imaging sensor to the first focus range;
adjust the focus of the second imaging sensor to the fourth focus range;
determine that the object by-passed the indicia scanner;
detecting that the object is in a bagging area; and
generate an alert signal that indicates at least one of an instance of scan avoidance or that the object by-passed the indicia scanner.

11. The product scanner of claim 1, wherein the imaging sensor comprises:
a first imaging sensor comprising a first fixed focus within the first focus range; and
a second imaging sensor comprising a second fixed focus within the second focus range, wherein the imaging system adjusts the focus of the imaging sensor by switching between the first imaging sensor and the second imaging sensor.

12. The product scanner of claim 1, wherein the imaging system is further configured to perform one or more of increasing or decreasing a brightness, increasing or decreasing an exposure length, increasing or decreasing a gain, increasing or decreasing a zoom, increasing or decreasing a field-of-view angle, increasing or decreasing a readout limit, or switching between imaging light sources.

13. The product scanner of claim 1, wherein the imaging system is configured to execute a machine vision application, wherein the machine vision application is configured to perform one or more of:
detecting one or more of the object or other item in a basket or a cart based, at least in part, on the first imaging data, wherein the object or the other item are located at a bottom of the basket or under the cart;
identifying the object based on at least one of the first imaging data or the second imaging data;
decoding the product indicia from at least one of the first imaging data or the second imaging data;
determining that the indicia data does not represent the object associated with the first imaging data or the second imaging data; or
generate an alert signal that indicates an instance of ticket switching.

14. The product scanner of claim 1, wherein the imaging system is configured to:
adjust the focus of one or more of the imaging sensor or a second imaging sensor to focus on the object or a user in response to one or more of an instance of scan avoidance or an instance of ticket switching.

15. An imaging system, comprising:
an imaging sensor comprising an imaging field-of-view, wherein the imaging field-of-view comprises a first focus range and a second focus range,
wherein the imaging system is configured to:
determine that an object is within the first focus range;
adjust a focus of the imaging sensor to the first focus range;
capture first imaging data that is representative of the object in the first focus range of the imaging field-of-view;
determine that the object is within the second focus range;
adjust the focus of the imaging sensor to the second focus range; and
capture second imaging data that is representative of the object in the second focus range of the imaging field-of-view.

16. The imaging system of claim 15, comprising:
a detection sensor comprising at least one of a 3D sensor, a range finder, or an infrared sensor, wherein the detection sensor is configured to:
detect the object at a position within the imaging field-of-view;
generate a detection signal that is representative of at least one of (i) the position within the imaging field-of-view or (ii) a distance between the position and the imaging sensor; and
cause transmission of the detection signal to the imaging system.

17. The imaging system of claim 15, comprising:
a second imaging sensor comprising a second imaging field-of-view, wherein the second imaging field-of-view comprises a third focus range and a fourth focus range, wherein the imaging system is configured to:
determine that the object is within the third focus range;
adjust a focus of the second imaging sensor to the third focus range;
capture third imaging data that is representative of the object in the third focus range of the second imaging field-of-view;
determine that the object is within the fourth focus range;
adjust the focus of the imaging sensor to the second focus range; and
capture fourth imaging data that is representative of the object in the fourth focus range of the second imaging field-of-view.

18. The imaging system of claim 17, wherein the imaging field-of-view of the imaging sensor comprises an overlap region that overlaps, at least in part, with the second imaging field-of-view of the second imaging sensor,
wherein the imaging system is configured to:
detect the object at a position within the overlap region based on a parallax between the imaging sensor and the second imaging sensor.

19. The imaging system of claim 18, wherein the position within the overlap region is further within (i) the second focus range of the imaging sensor and (ii) the third focus range of the second imaging sensor,
wherein the imaging system is configured to:
adjust the focus of the imaging sensor to the second focus range;
adjust the focus of the second imaging sensor to the third focus range;
determine that the object was scanned by an indicia scanner; and
search for another object within at least one of (i) the first focus range of the imaging sensor or (ii) the fourth focus range of the second imaging sensor.

20. A computer-implemented method for adjusting a focus of an imaging system, the computer-implemented method comprising:
determining that an object is within a first focus range associated with an imaging sensor;
adjusting a focus of the imaging sensor to the first focus range;
capturing first imaging data that is representative of the object in the first focus range;
determining that the object is within a second focus range associated with the imaging sensor;
adjusting the focus of the imaging sensor to the second focus range; and
capturing second imaging data that is representative of the object in the second focus range.
